(19) United States
(12) Patent Application Publication
(10) Pub. No.: US 2026/0351126 A1
(43) Pub. Date: Nov. 5, 2026

(54) SYSTEMS, APPARATUSES, METHODS, AND COMPUTER PROGRAM PRODUCTS FOR PREDICTING CLEAR AIR TURBULENCE

(71) Applicant: Honeywell International Inc., Charlotte, NC (US)

(72) Inventors: Rajesh Chaubey, Bangalore (IN); Srihari Jayathirtha, Phoenix, AZ (US); Kirupakar J, Phoenix, AZ (US)

(21) Appl. No.: 19/664,252

(22) Filed: Apr. 30, 2026

Related U.S. Application Data
(60) Provisional application No. 63/798,302, filed on May 1, 2025.

(51) Int. Cl. G08G 5/76; G08G 5/23

(52) U.S. Cl. CPC G08G 5/76; G08G 5/23

(57) ABSTRACT

Embodiments of the present disclosure provide clear air turbulence prediction techniques. An input dataset including wind data and temperature data for a spatial region associated with a flight path for an aircraft may be received. Predicted turbulence dataset associated with the spatial region may be generated by applying the input dataset to a prediction model configured to generate turbulence intensity data for the spatial region. The predicted turbulence dataset may include a turbulence intensity classification corresponding to one or more locations within the spatial region based on the turbulence intensity data. Performance of one or more prediction-based actions may be initiated based at least in part on the predicted turbulence dataset.

### CROSS REFERENCE TO RELATED APPLICATIONS

This application claims priority to U.S. Provisional Application No. 63/798,302 filed May 1, 2025, which is incorporated herein by reference in its entirety.

### TECHNOLOGICAL FIELD

Embodiments of the present disclosure generally relate to predicting clear air turbulence; and particularly to systems, apparatuses, methods, and computer program products for predicting clear air turbulence in aircraft systems.

### BACKGROUND

Various embodiments of the present disclosure address technical challenges related to clear air turbulence detection systems. Through applied effort, ingenuity, and innovation many deficiencies of existing systems have been solved by developing solutions that are in accordance with the embodiments as discussed herein, many examples of which are described in detail herein.

### BRIEF SUMMARY

In accordance with one aspect of the present disclosure, a computer-implemented method for prediction clear air turbulence is provided. In some embodiments, the computer-implemented method includes receiving, by one or more processors, an input dataset comprising wind data and temperature data for a spatial region associated with a flight path for an aircraft; generating, by the one or more processors, predicted turbulence dataset associated with the spatial region by applying the input dataset to a prediction model configured to generate turbulence intensity data for the spatial region, wherein the predicted turbulence dataset comprises a turbulence intensity classification corresponding to one or more locations within the spatial region based on the turbulence intensity data; and initiating, using the one or more processors, performance of one or more prediction-based actions based at least in part on the predicted turbulence dataset.

In some embodiments, the wind data comprises measured wind metric for one or more locations within the spatial region.

In some embodiments, the temperature data comprises measured temperature for the one or more locations within the spatial region, wherein each location is defined by a flight level and lateral distance from a reference location.

In some embodiments, generating the predicted turbulence dataset comprises generating atmospheric variation dataset based on the wind data and temperature data; generating predicted airflow direction data based on the atmospheric variation dataset; and generating the turbulence intensity data based on the atmospheric variation dataset or the predicted airflow direction data.

In some embodiments, initiating the performance of the one or more prediction-based actions comprises generating a representation of the predicted turbulence dataset; and causing display of the representation of the predicted turbulence dataset on a display of a client computing device.

In some embodiments, the turbulence intensity data comprises calculated turbulence intensity for each of the one or more locations within the spatial region.

In some embodiments, the atmospheric variation dataset comprises one or more of pressure variation data or temperature variation data.

In accordance with another aspect of the present disclosure, an apparatus for predicting clear air turbulence is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product for predicting clear air turbulence is provided. The computer program product in some embodiments includes at least one non-transitory computer-readable storage medium having computer program code stored thereon. The computer program code in execution with at least one processor is configured for performing any of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an example system environment within which embodiments of the present disclosure may operate.

FIG. 2 illustrates a block diagram of an example apparatus that may be specially configured in accordance with an example embodiment of the present disclosure.

FIG. 3 illustrates a visualization of an example data environment for generating clear air turbulence predictions in accordance with at least one example embodiment of the present disclosure.

FIG. 4 illustrates an operational example of a weather model in accordance with at least one example embodiment of the present disclosure.

FIG. 5 illustrates an operational example of a visualization of pressure variation along a flight path in accordance with at least on example embodiment of the present disclosure.

FIG. 6 illustrates an interface showing a visualization of turbulence intensity classification along a flight path in accordance with at least on example embodiment of the present disclosure.

FIG. 7 illustrates an example flight management system in which example embodiments of the present disclosure may operate.

FIG. 8 illustrates an example connected aircraft system architecture in which example embodiments of the present disclosure may operate.

FIG. 9 illustrates a flowchart including example operations of an example process for generating clear air turbulence predictions in accordance with at least one example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the present disclosure may be embodied in many different forms and should not be construed as limited to the embodiments set forth herein, rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### Overview and Technical Improvements

Various embodiments of the present disclosure address technical challenges related to clear air turbulence prediction systems. One of the greatest dangers to aviation is turbulence; particularly clear air turbulence (CAT). Clear air turbulence may be defined as sudden severe turbulence occurring in cloudless regions that causes violent buffeting of aircraft. Clear air turbulence may not be detected with the naked eye and very difficult to detect with a conventional radar, with the result that it is difficult for aircraft pilots to detect and avoid it. Clear air turbulence can be hazardous to the comfort, and potentially the safety, of air travelers. Clear air turbulence in the jet stream may continue to become stronger overtime and may become more frequent based on, for example, climate change. Flight paths may become more convoluted to avoid stronger and more frequent patches of turbulence, in which case journey times will lengthen and jet fuel consumption will increase. Moreover, standard airplane radars cannot detect clear air turbulence, as clear air turbulence is not associated with clouds that show unpredictable movement of the air.

Example embodiments of the present disclosure address the above challenges by providing clear air turbulence techniques and systems that provides accurate turbulence prediction at various flight levels, such that operators (e.g., pilots, air traffic controller, or the like) may leverage the clear air turbulence predictions to make informed decisions about higher flight levels with smoother air. Being able to climb to these altitudes will result in a more optimal fuel burn, which will ultimately lead to reduced carbon dioxide emissions. In this regard, example embodiments of the present disclosure provide various technical advantages. The integration of wind data and temperature data at multiple flight levels and lateral distances from reference points along the flight path enables comprehensive atmospheric parameter computation across a three-dimensional spatial region surrounding the aircraft route. This approach provides turbulence prediction capabilities that address limitations of conventional detection approaches, wherein standard airplane radars cannot detect clear air turbulence because clear air turbulence is not associated with clouds that show unpredictable movement of the air. By leveraging the physical phenomena relating pressure, density, and temperature, the prediction techniques described herein enable identification of turbulence conditions before the aircraft encounters them. Example embodiments leverage the relationship between atmospheric parameters to compute pressure variations, temperature variations, and/or density variations at computation points within the spatial region, and estimate air stream directions through these variations to identify potential vortices or air pockets that may be indicative of clear air turbulence conditions.

Example embodiments provide accurate turbulence data and predictions at various flight levels, that enables pilots to make informed decisions about higher flight levels with smoother air. In this regard, climbing to these altitudes may result in a more favorable fuel burn for the aircraft, which may result in reduced carbon dioxide emissions. The clear air turbulence prediction techniques may further provide a decision support tool for aircraft crew to adhere to an optimized path, thereby facilitating cost and time savings as well as improved passenger comfort. The clear air turbulence prediction techniques may reduce aircraft crew workload for handling turbulence situations effectively by providing proactive alerts and recommendations. For example, for light or moderate turbulence intensity classifications, the system may generate alerts recommending passenger notification, while for severe or extreme turbulence intensity classifications, the system may generate recommendations for flight path deviations including flight level changes or lateral route modifications. The Clear Air Turbulence Situational Display capabilities along the flight plan may facilitate flight planning improvements with respect to weather awareness and avoidance. Additionally, the computation of atmospheric parameters along and around the aircraft route within a predetermined lateral distance, which represents an operationally safe deviation distance from the route, enables evaluation of alternative flight paths that may avoid or minimize exposure to predicted clear air turbulence regions.

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “information,” and similar terms may be used interchangeably to refer to data capable of being transmitted, received, or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry or digital circuitry); (b) combinations of circuits and computer program product(s) comprising software or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, or the like. As a further example, as used herein, the term “circuitry” also includes an implementation comprising one or more processors or portion(s) thereof and accompanying software or firmware. As another example, the term “circuitry” as used herein also includes, for example, a baseband integrated circuit or applications processor integrated circuit for a mobile phone or a similar integrated circuit in a server, a cellular network device, other network device, or other computing device.

As used herein, a “computer-readable storage medium,” refers to a physical storage medium (e.g., volatile, or non-volatile memory device), and may be differentiated from a “computer-readable transmission medium,” which refers to an electromagnetic signal. A computer-readable storage medium may be a non-transitory medium.

As used herein, the terms “data structure,” “data object,” or “data set” refer interchangeably to data capable of being transmitted, received, or stored. For example, a predicted asset may be associated with one or more data elements or values in a computer-readable storage medium or computer-readable transmission medium, that represents content that is configured for use or display by one or more software applications, services, microservices, or the like.

As used herein, the terms “application,” “software application,” “app,” “computer program,” “service,” or similar terms refer to a computer program or group of computer programs designed to perform coordinated functions, tasks, or activities. Such computer programs may be operated by or for the benefit of a user or group of users. An application may be configured to provide access to one or more services provided by an entity. For example, an application may be configured to provide access to services provided by visual media content provider systems. An application may run on a server or group of servers, such as, but not limited to, web servers and application servers. In some embodiments, an application may be run on or across one or more other computing devices (e.g., user devices). For example, an application may be configured to be accessed via a web browser (e.g., a website accessed via the Internet using a browser), a dedicated client running on a user device, or the like. In some examples, an application may be configured for use by and interaction with one or more local, networked or remote computing devices.

The term “client computing device,” “client device” “client computing entity” and similar terms may be used interchangeably to refer to a computer comprising at least one processor and at least one memory. In some embodiments, the client computing device may further comprise one or more of: a display device for rendering one or more of a graphical user interface, a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” and the aforementioned similar terminology may refer to computer hardware or software that is configured to access a service or functionality offered by a system such as computing system 101 described herein, for example, a service or functionality that is made available by a server. Such a server may be in a different location or another computing system, in which case the client computing device may access the server by way of a network. Client computing devices may include, without limitation, smart phones, tablet computers, kiosk, terminal, laptop computers, wearables, personal computers, enterprise computers, or the like. In some examples, client computing devices, as described herein, may communicate with or otherwise access a computing system 101, via one or more networks. In some embodiments, the at least one processor and the at least one memory need not be physically co-located with other elements of the client computing device (e.g., in a terminal environment, in which a display may be separated from a server-based processor or memory).

In some embodiments, a client computing device may be associated with a particular operator. For example, a client computing device may be operated by an operator (e.g., pilot, or the like) of an aircraft. In some embodiments, a client computing device may be a general purpose computing device having special purpose computer programming stored or executed thereon (e.g., a program, application, or web browser session running on a personal computer or smartphone). In some embodiments, a client computing device may be configured as a terminal or other remote viewing apparatus configured to display graphical user interfaces and associated information generated on a remote computing device. In some embodiments, a client computing device may be a special purpose computing device configured to perform the various functions described herein. Various embodiments of client computing devices may include, without limitation, smartphones, tablets, laptops, terminals, kiosks, personal computers, desktop computers, enterprise computers, or the like. Various embodiments of client computing devices may operate using different operating systems including, without limitation, IOS, ANDROID, WINDOWS, MACOS, LINUX, CHROME OS, or the like.

As used herein, the term “graphical user interface” refers to a representation of a software interface. For example, a graphical user interface may be the visual representation of a software such as a website, mobile application, desktop application, or the like, that may be used to generally interface with the software. By way of example, images, buttons, links, backgrounds, text fields, or the like, may be included within or make up a graphical user interface. In various examples, a graphical user interface may be configured for display on one or more screens (e.g., a screen of a mobile phone, a personal computer, or the like).

As used herein, the term “application programming interface” and “API” refers to a computing interface that defines indication inputs between applications, services, microservices, computing devices, repositories, or the like. An API may define formatting for one or more of a programming code call, request, function, procedure, notification, data object, data structure, or the like. Non-limiting examples of an application programming interface may include JavaScript Object Notation (JSON), Extensible Markup Language (XML), Simple Object Access Protocol (SOAP), Hypertext Markup Language (HTML), the like, or combinations thereof.

As used herein, the term “API request” refers to a structured communication sent to an API to request data or functionality. For example, the API request may be sent to an API associated with a computing system, computing device, or application, as described herein. In some examples, the API request may identify an application such as, for example, an application with respect to which the API request is intended. In some examples, the API request may be formatted according to a predefined schema, using, for example, a standard data interchange format such as JSON, XML, or the like.

As used herein, the term “repository,” “database,” and similar terms may be used interchangeably to refer to a computing location associated with a system where data is stored, accessed, modified, and otherwise maintained by the system. A repository may be used to store data in association with a data storage protocol or a query language. In certain embodiments, a repository may embody a data storage device or devices, a separate database server or servers, or as a combination of data storage devices and separate database servers. Further, in some embodiments, a repository may be embodied as a distributed repository such that some of the stored data is stored centrally in a location within the repository and other data stored in a single remote location or a plurality of remote locations. Alternatively, in some embodiments, a repository may be distributed over a plurality of remote storage locations only such as in a cloud storage environment.

As used herein, the term “machine learning model” refers to one or more processes, algorithms, or other data entity that describes parameters, hyper-parameters, defined operations, or defined mappings of a model that is configured to process one or more inputs in accordance with one or more trained parameters of the machine learning models in order to generate a prediction. An example of a machine learning model is a mathematically derived algorithm (MDA). An MDA may comprise any algorithm trained using training data to predict one or more outcome variables. Without limitation, an MDA, as used herein, may comprise machine learning frameworks including neural networks, deep neural networks, generative adversarial networks, convolutional neural networks, recurrent neural networks, large language models, generative pre-trained transformers (GPT), support vector machines, gradient boosts, decision trees, random forests, Markov models, adaptive Bayesian techniques, and statistical models (e.g., timeseries-based forecast models such as autoregressive models, autoregressive moving average models, or an autoregressive integrating moving average models). Additionally, and without limitation, an MDA, as used in the singular, may include ensembles using multiple machine learning or statistical techniques.

As used herein, the term “generative artificial intelligence model,” “generative AI model”, and similar terms may be used interchangeably to refer to one or more artificial intelligence models, including but not limited to some example machine learning models, configured to generate new outputs in response to a prompt or other input data. A generative AI model may include a large language model such as, for example, a generative pre-trained transformer (GPT) model.

As used herein the term “prompt” or “model prompt” refers to instructions or context provided to a generative AI model to guide the generative AI model’s output generation. A prompt may serve as the starting point for interaction with the generative AI model, setting the stage for the type of output expected from the generative AI model or elicit an API request having a particular API schema from the generative AI model. The prompt may be a carefully engineered input to the generative AI model that encapsulates the specific requirements of an API/API schema for an application. The prompt may be implemented as text that is sent to the generative AI model. For example, the prompt may be implemented as a string of text that is sent to the generative AI model via an API associated with the generative AI model.

As used herein the term “aircraft” refers to any machine, robot, computing devices, and/or apparatus comprised of hardware, software, firmware, and/or any combination thereof, that maneuvers throughout an environment through a medium, such as air. In some contexts, the aircraft is utilized to transport objects, entities (e.g., people, animals, or other beings), and/or other onboard cargo. In some situations, the aircraft may be transporting no object except for the aircraft itself. Examples of an aircraft include airplanes, helicopters, unmanned aerial vehicles (e.g., drones), vehicles configured to operate in an urban air mobility (UAM) environment, and/or the like. An aircraft is not limited to the examples listed herein and may include other types of transportation device. In some embodiments, the aircraft is configured to perform an aircraft mission (also referred to herein as a flight).

As used herein the terms “aircraft mission”, “aircraft flight”, or “flight” refer to a defined series of operations performed by the aircraft. For example, an aircraft mission/flight may include a defined series of operations performed by the aircraft to move from a first airport to a second airport. As another example, an aircraft mission/flight may include a defined series of operations performed by the aircraft to move from a home location (e.g., a docking station of a UAV) to a destination (e.g., a package drop off location) and/or from a destination location to a home location. In this regard, in some embodiments, an aircraft mission/flight may comprise the aircraft performing preflight procedures, (e.g., at the gate before a flight, at a home location of a UAV, etc.), leaving a gate or home location, taxiing, taking off (e.g., a visual-assisted automatic landing), climbing, cruising (e.g., a cruise phase between takeoff and landing where the aircraft is at a cruise altitude), descending, landing (e.g., a visual-assisted automatic landing), parking at a gate or a destination location, performing post flight procedures (e.g., at the gate after a flight, at a destination location, etc.), and/or the like. For example, an aircraft mission may include a defined series of operations that includes leaving the gate at a first airport or a docking station at a home location, taxiing to a runway at the first airport (e.g., an originating airport), taking off from the first airport or the home location, climbing (e.g., to a cruising altitude), flying (e.g., at a cruise altitude) to a second airport (e.g., a destination airport) or a destination location, descending (e.g., from a cruising altitude), landing at the second airport or a destination location, taxiing to a gate at the second airport or a destination location, and/or parking at a gate at the second airport or at a destination location.

### EXAMPLE SYSTEMS, APPARATUSES, AND DATAFLOW

Various embodiments of the present disclosure may be implemented as methods, apparatus, systems, computing devices, computer program products, or the like. As such, embodiments of the present disclosure may take the form of an apparatus, system, computing device, computing entity, or the like executing instructions stored on a computer-readable storage medium to perform certain steps or operations. Thus, embodiments of the present disclosure may take the form of an entirely hardware embodiment, an entirely computer program product embodiment, or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, or apparatus, systems, computing devices, computing devices, or the like carrying out instructions, operations, steps, and similar words used interchangeably (e.g., the executable instructions, instructions for execution, program code, or the like) on a computer-readable storage medium for execution. For example, retrieval, loading, and execution of code may be performed sequentially such that one instruction is retrieved, loaded, and executed at a time. In some example embodiments, retrieval, loading, or execution may be performed in parallel such that multiple instructions are retrieved, loaded, or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

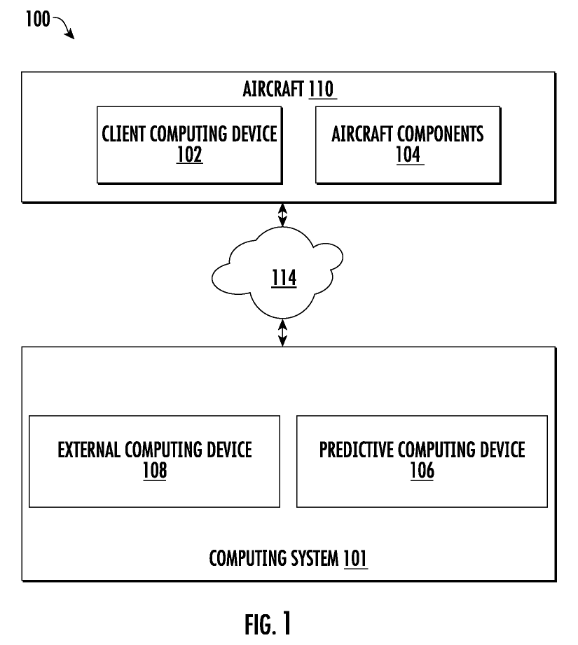

In this regard, FIG. 1 shows an example system environment 100 within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system environment 100 disclosed therein is merely presented to provide an example basis and context for the facilitation of some of the features, aspects, and uses of the methods, apparatuses, computer readable media, and computer program products disclosed and contemplated herein.

The system environment 100 comprises a computing system 101 configured to perform clear air turbulence prediction process, including detecting the presence of clear air turbulence along a flight path. The example system environment 100 and computing system 101 may be used in a plurality of domains and not limited to any specific application as disclosed herewith. In some embodiments, the computing system 101 may be utilized onboard a mobile platform such as, for example, an aircraft 110 equipped with or otherwise associated with the computing system 101. In some embodiments, the aircraft 110 may describe any machine, robot, computing devices, and/or apparatus comprised of hardware, software, firmware, and/or any combination thereof, that maneuvers throughout an environment through a medium, such as air. In some contexts, the aircraft 110 is utilized to transport objects, entities (e.g., people, animals, or other beings), and/or other onboard cargo. In some situations, the aircraft 110 may be transporting no object except for the aircraft itself. Examples of the aircraft 110 include airplanes, helicopters, unmanned aerial vehicles (e.g., drones), vehicles configured to operate in an urban air mobility (UAM) environment, and/or the like. In some embodiments, the aircraft 110 is not limited to the examples listed herein and may include other types of transportation device.

In some embodiments, the aircraft 110 is associated with a determinable location. The determinable location of the aircraft 110 in some embodiments represents an absolute position (e.g., GPS coordinates, latitude and longitude locations, an address, and/or the like) or a relative position of the aircraft 110 (e.g., an identifier representing the location of the aircraft 110 as compared to one or more other aircraft, one or more buildings (e.g., an airport), an enterprise headquarters, or general description in the world for example based at least in part on continent, state, ocean, or other definable region). In some embodiments, the aircraft 110 includes or otherwise is associated with a location sensor and/or software-driven location services that provide the location data corresponding to the aircraft 110. In other embodiments, the location of the aircraft 110 is stored and/or otherwise determinable to one or more systems.

In some embodiments, the aircraft 110 and/or one or more other aircraft are configured to perform an aircraft mission. In some embodiments, an aircraft mission is a defined series of operations performed by the aircraft 110 and/or one or more other aircraft. For example, an aircraft mission may include a defined series of operations performed by the aircraft 110 and/or one or more other aircraft to move from a first airport to a second airport. As another example, an aircraft mission may include a defined series of operations performed by the aircraft 110 and/or one or more other aircraft to move from a home location (e.g., a docking station of a UAV) to a destination (e.g., a package drop off) and/or from a destination location to a home location. In this regard, in some embodiments, an aircraft mission may include a defined series of operations performed by the aircraft 110 and/or one or more other aircraft that include operations performed while the aircraft 110 and/or one or more other aircraft is performing preflight procedures, (e.g., at the gate before a flight, at a home location of a UAV, etc.), leaving a gate or home location, taxiing, taking off (e.g., a visual-assisted automatic landing), climbing, cruise (e.g., a cruise phase between takeoff and landing where the aircraft 110 is at a cruise altitude), descending, landing (e.g., a visual-assisted automatic landing), parking at a gate or a destination location, performing post flight procedures (e.g., at the gate after a flight, at a destination location, etc.), and/or the like. For example, an aircraft mission may include a defined series of operations that includes leaving the gate at a first airport or a docking station at a home location, taxiing to a runway at the first airport (e.g., an originating airport), taking off from the first airport or the home location, climbing (e.g., to a cruising altitude), flying (e.g., at a cruise altitude) to a second airport (e.g., a destination airport) or a destination location, descending (e.g., from a cruising altitude), landing at the second airport or a destination location, taxiing to a gate at the second airport or a destination location, and/or parking at a gate at the second airport or at a destination location.

In some embodiments, the computing system 101 comprises a predictive computing device 106. In some embodiments, the predictive computing device 106 is electronically and/or communicatively coupled to the aircraft 110, a client computing device 102, and/or one or more aircraft components 104. For example, the predictive computing device 106 may be configured to communicate with the aircraft 110, client computing device 102, and/or one or more aircraft components 104 using one or more wired or wireless communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, or firmware required to implement it (such as, e.g., network routers, or the like).

In some embodiments, the predictive computing device 106 is configured via hardware, software, firmware, and/or a combination thereof to perform various functions associated with the computing system 101, including clear air turbulence prediction process configured to predict the presence of clear air turbulence along a flight path. In some embodiments, the predictive computing device 106 is configured via hardware, software, firmware, and/or a combination thereof, to perform data intake of one or more types of data. Additionally, or alternatively, in some embodiments, the predictive computing device 106 is configured via hardware, software, firmware, and/or a combination thereof, to generate and/or transmit command(s) and/or instruction(s) that control, adjust, or otherwise impact operations of one or more of the aircraft 110, the client computing device 102, and/or the one or more aircraft components 104. Additionally, or alternatively, in some embodiments, the predictive computing device 106 is configured via hardware, software, firmware, and/or a combination thereof, to perform data reporting, provide data, and/or other data output process(es) associated with monitoring or otherwise analyzing operations of one or more of the aircraft 110, the client computing device 102, and/or the one or more aircraft components 104. In this regard, in various embodiments, the predictive computing device 106 may be configured to execute and/or perform one or more operations and/or functions described herein.

In some embodiments, the predictive computing device 106 is a cloud-based device. In such some embodiments, the predictive computing device 106 may be located remotely from the aircraft 110. In this regard, for example, the predictive computing device 106 may be located in a remote cloud server and electronically and/or communicatively coupled to the aircraft 110, the client computing device 102, and/or the one or more aircraft components 104 via at least the network 114. In some embodiments, the predictive computing device 106 is an onboard device. For example, in some embodiments, the computing system 101 and/or the predictive computing device 106 may be embodied by the aircraft 110, the client computing device 102, or an aircraft component 104.

In some embodiments, a computing device, such as the predictive computing device 106 or external computing device 108 may comprise one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, or any combination of devices or entities adapted to perform the functions, operations, or processes described herein. Such functions, operations, or processes may comprise, for example, transmitting, receiving, operating on, processing, displaying, storing, determining, creating/generating, training one or more machine learning models or generative AI models, monitoring, evaluating, comparing, or similar terms used herein interchangeably. In some embodiments, these functions, operations, or processes may be performed on data, content, information, or similar terms used herein interchangeably.

As described above, in various embodiments, the predictive computing device 106 is configured to perform a clear air turbulence prediction process according to one or more techniques of the present disclosure. In various embodiments, the predictive computing device 106 includes one or more components configured via hardware, software, firmware, or combination thereof to perform one or more functionalities associated with the predictive computing device 106, including one or more operations associated with clear air turbulence prediction process, as described herein. In various embodiments, such one or more components of the predictive computing device include a weather modeling module, a trajectory generator module, a clear air turbulence parameters prediction module (CAT parameters prediction module), a clear air turbulence intensity computation module (CAT intensity computation module), and/or a display module.

The weather modeling module may be configured to generate weather models based on input data including wind data and temperature data received from various sources such as pilot-entered data, uplinked data, or network weather data. For example, the weather module may be configured to perform modeling operation on the received input data to generate a weather model, as described herein. The weather model may be leveraged by one or more other components of the predictive computing device 106 to compute atmospheric parameters such as pressure, density, and/or temperature predictions.

In various embodiments, the weather model comprises data representative and/or indicative of winds and temperatures at each of one or more reference points (e.g., waypoints) along the flight path. Additionally, the weather model includes data representative and/or indicative of winds and temperatures at a lateral distance left and right from a given reference point along the route and at different flight levels. For example, the weather model may include wind and temperature data at a predetermined distance (e.g., configurable distance value) from a reference point (waypoint), thereby strengthening the capability of the predictive computing device 106 (or one or more components thereof) to compute atmospheric parameters, such as pressure, density, and temperature, across a broader spatial region surrounding the flight path.

The predetermined distance may be any distance that represents an operationally safe deviation distance from the route. For example, in some embodiments, the predetermined distance is approximately 25 nautical miles on either side of the flight path. In some example, the predetermined distance corresponds to a lateral range within which the aircraft could safely deviate from the planned route if necessary to avoid turbulence. In some embodiments, the predetermined distance may be configurable based on operational requirements, aircraft performance characteristics, airspace constraints, or regulatory considerations. The predetermined distance defines the lateral extent of the spatial region for which atmospheric variation data is computed, thereby establishing the boundaries within which the one or more prediction models evaluates pressure variations, temperature variations, and potential clear air turbulence conditions. In some embodiments, the predetermined distance may vary along different segments of the flight path based on factors such as proximity to airports, restricted airspace, terrain, or other operational considerations that may affect the available lateral deviation options for the aircraft.

In some embodiments, the weather modeling module is configured to integrate measured weather parameters at the aircraft location with the weather model data to enhance the prediction accuracy (e.g., atmospheric parameters predictions). The weather modeling module may receive input data from multiple sources including onboard sensors that measure current atmospheric conditions at the aircraft location, pilot-entered weather data input via a flight management system interface, uplinked weather data received from ground-based systems or air traffic control, and network weather data obtained from connected aircraft systems or cloud-based weather services. In some embodiments, the weather modeling module generates weather models that define atmospheric data for a plurality of computation points within a spatial region, wherein each computation point is associated with a specific flight level and lateral distance from a reference location along the flight path, enabling comprehensive atmospheric parameter computation along and around the aircraft route limited (e.g., bounded, constrained, or the like) by a predetermined lateral distance (e.g., approximately 25 nautical miles in some embodiments) which represents an operationally safe deviation distance from the route.

The trajectory generator module may be configured to generate trajectory data at various flight levels along and around the planned route/flight path. In some embodiments, the trajectory generator module leverages flight management system (FMS) trajectory computation capabilities to determine aircraft position, altitude, and timing information along the flight path. The trajectory generator module may be configured to compute trajectory data for multiple flight levels, including the current aircraft flight level and alternative flight levels above and below the current flight level, thereby enabling the computing system 101 or predictive computing device 106 to evaluate atmospheric conditions across a vertical range of the spatial region. In some embodiments, the trajectory generator module generates trajectory data that defines one or more computation points within the spatial region, wherein each computation point corresponds to a specific geographic location, flight level, and lateral offset from the planned route centerline. The trajectory generator module may be configured to integrate with the weather modeling module to associate atmospheric data with each computation point along the trajectory, enabling comprehensive atmospheric parameter computation along and around the aircraft route/flight path. In some embodiments, the trajectory generator module is configured to generate trajectory data extending laterally from the flight path up to a predetermined distance (such as, for example, approximately 25 nautical miles) on either side of the route, that represents an operationally safe deviation distance from the route. The trajectory generator module may also be configured to update trajectory data in real-time based on current aircraft position and flight conditions, thereby enabling dynamic clear air turbulence predictions as the aircraft progresses along the flight path.

The CAT parameters prediction module may be configured to generate CAT parameter predictions such as airflow direction predictions, atmospheric variation predictions (e.g., including pressure variation predictions, temperature variation predictions, and/or density variation predictions). In some embodiments, the CAT parameter prediction module may be configured to compute and/or leverage atmospheric parameters, such as pressure, density, and temperature. The CAT parameters prediction module may be configured to generate the CAT parameter predictions based on the relationship between pressure, density, and/or temperature. For example, the CAT parameters prediction module may leverage the physical phenomena wherein aircraft in level flight rely on a constant air density to retain stability, and where air density is significantly different, for instance because of temperature gradient, especially at the tropopause, clear air turbulence can occur. In this regard, a temperature gradient represents the change of temperature over a distance in some given direction, and where the temperature of a gas changes, so does its density, and where the density changes, clear air turbulence can appear.

The CAT parameters prediction module may be configured to compute pressure data, density data, and/or temperature data for each of one or more defined locations within the spatial region based on the atmospheric data (e.g., wind data, temperature data, and/or the like) for the respective defined location. In some embodiments, the CAT parameters prediction module computes atmospheric parameters at locations extending laterally from the flight path, for example, up to approximately 25 nautical miles on either side of the route (or any other value that represents an operationally safe deviation distance). The CAT parameters prediction module may be further configured to compute atmospheric parameters at multiple flight levels, including at the aircraft flight level and at flight levels above and below the aircraft flight level (e.g., at 50 feet below and 50 feet above the aircraft flight level), to identify atmospheric conditions across a vertical range of the spatial region. In some embodiments, the CAT parameters prediction module is configured to estimate air stream directions through pressure and temperature variations over the computation region, wherein pressure variations at a point of interest are leveraged in determining the direction of airflow based on the principle that air flows from high pressure to low pressure areas. For example, the CAT parameters prediction module may be configured to generate predicted airflow direction data, as described herein.

The CAT intensity computation module may be configured to generate turbulence intensity data and clear air turbulence predictions based on at least the computed atmospheric parameters. In some embodiments, the CAT intensity computation module leverages eddy dissipation rate (EDR) values to classify turbulence intensity as null, light, light-to-moderate, moderate, moderate-to-severe, severe, severe-to-extreme, or extreme (or other classifications).

In various embodiments, the predictive computing device 106 (or one or more components thereof) leverages one or more prediction models to perform one or more operations associated with clear air turbulence prediction process, as described herein. For example, in some embodiments, at least the CAT intensity computation module leverages the at least one prediction model to perform one or more functionalities of the CAT intensity computation module. In some embodiments, the one or more prediction models is configured to receive atmospheric variation data, including pressure variation data and temperature variation data, and generate turbulence intensity predictions based on the relationships between these atmospheric parameters. The one or more prediction models may be further configured to compute EDR values based on the atmospheric variation data and aircraft-specific parameters such as aircraft weight, airspeed, and altitude. For example, in some embodiments, the one or more prediction models may leverage the relationship between root mean-square vertical acceleration of the aircraft in turbulence and the cube-root of the EDR to generate turbulence intensity predictions.

In some embodiments, the one or more prediction models is configured to identify potential vortices or air pockets based on directional differences in pressure variations at computation points within the spatial region. For example, the one or more prediction models may determine that where pressure variations indicate air flowing from high pressure to low pressure in different directions at a computation point, the directional difference in pressure variations may lead to potential vortices or air pockets at that computation point, which may be indicative of clear air turbulence. The one or more prediction models may be further configured to compute pressure and temperature variations at multiple flight levels, including at the aircraft flight level and at flight levels above and below the aircraft flight level (e.g., at 50 feet below and 50 feet above the aircraft flight level in some embodiments or at other distances in some other embodiments), to identify turbulence conditions across a vertical range of the spatial region. The one or more prediction models may be implemented using one or more machine learning algorithms, statistical models, physics-based algorithms, or combinations thereof configured to process the input atmospheric data and generate turbulence intensity predictions for locations along and around the aircraft flight path. In some embodiments, the one or more prediction models leverages the physical phenomena relating pressure, density, and temperature, wherein where the temperature of a gas changes, so does its density, and where the density changes, clear air turbulence can appear.

The display module may be configured to generate visual representations of the predicted turbulence data for display on a navigation display or other suitable interface, enabling pilot awareness and informed decision-making regarding flight level changes or lateral route deviations. In some embodiments, the display module is configured to render turbulence intensity classifications as graphical indicators overlaid on a navigation display, wherein each graphical indicator corresponds to a location within the spatial region and visually distinguishes between turbulence intensity levels such as null, light, light-to-moderate, moderate, moderate-to-severe, severe, severe-to-extreme, or extreme. The visual representations may include color-coded regions, icons, or other graphical elements that allow pilots to quickly assess turbulence conditions along the planned flight path and at alternative flight levels above and below the current aircraft flight level.

In some embodiments, the display module is configured to generate a clear air turbulence situational display that presents turbulence predictions along the flight plan/flight path, thereby facilitating flight planning improvements with respect to weather awareness and avoidance. The display module may be further configured to generate alerts or notifications based on the predicted turbulence dataset, wherein for light and/or moderate turbulence intensity classifications, the display module may generate a proactive alert recommending passenger notification (e.g., "seat belt on"), and for severe or extreme turbulence intensity classifications, the display module may generate recommendations for flight path deviations including flight level changes or lateral route modifications. In some embodiments, the display module is configured to present turbulence predictions at multiple flight levels simultaneously, enabling pilots to identify smoother air at higher or lower altitudes and make informed decisions about altitude changes that may result in more optimal fuel burn and reduced carbon dioxide emissions.

The predictive computing device 106 or one or more external computing devices 108 may comprise or otherwise may be associated with storage subsystems that may be configured to store input data, training data, or the like that may be used by the respective computing devices to perform predictive data analysis or training operations of the present disclosure. In addition, the storage subsystems may be configured to store model definition data used by the respective computing devices to perform various predictive data processing or training tasks. The storage subsystem may comprise one or more storage units, such as multiple distributed storage units that are connected through a computer network. A storage unit in the respective computing devices may store at least one of one or more data assets or a set of data about the computed properties of one or more data assets. Moreover, each storage unit in the storage subsystems may comprise one or more non-volatile storage or volatile storage media similar to or different than the non-volatile or volatile computer-readable storage media discussed above.

In some embodiments, the predictive computing device band/or external computing device 108 is configured via hardware, software, firmware, and/or a combination thereof configured to train, implement, use (e.g., execute an inference operation(s)), update (e.g., fine-tune), and evaluate machine learning models/AI models (e.g., one or more prediction models) in accordance with one or more training or inference operations of the present disclosure. In some embodiments, the predictive computing device 106 includes or is associated with one or more prediction models, as described herein. In some embodiments, the predictive computing device 106 leverages the one or more prediction model to perform and/or facilitate clear air turbulence prediction process, as described herein.

In some embodiments, the predictive computing device 106 is configured via hardware, software, firmware, and/or a combination thereof to receive or transmit one or more datasets, objects, or the like from or to the aircraft 110, client computing device 102, aircraft components 104, and/or external computing devices 108 to perform one or more steps/operations of one or more techniques (e.g., data retrieval techniques, predictive data analysis techniques, or the like) described herein. For example, the aircraft 110, client computing device 102, aircraft components 104, and/or external computing devices 108 may comprise or be associated with one or more devices that may be configured to receive, transmit, store, manage, or facilitate datasets, or the like. The aircraft 110, client computing device 102, aircraft components 104, and/or external computing devices 108, for example, may comprise data sources that may provide such datasets, or the like to the predictive computing device 106 which may leverage the datasets, such as wind data, temperature data, model data, training data, or the like to perform one or more steps/operations of the present disclosure, as described herein. For example, such datasets may be leveraged by the predictive computing device 106 to perform and/or facilitate clear air turbulence prediction process configured to predict the presence of clear air turbulence along a flight path.

In some examples, the datasets may comprise an aggregation of data from across a plurality of data sources (e.g., aircraft 110, client computing device 102, aircraft components 104, and/or external computing devices 108) into one or more aggregated datasets. The one or more data sources, for example, may be associated with one or more data repositories, cloud platforms, compute nodes, organizations, or the like, which may be individually or collectively leveraged by the predictive computing device 106 to obtain and aggregate data which may be used in one or more steps/operations of techniques, described herein. In some examples, the datasets received by the predictive computing device 106 may be stored in one or more databases/storage units of a storage subsystem associated with the predictive computing device 106.

In some embodiments, the predictive computing device 106 may be configured to receive one or more predictive models generated, trained/configured and subsequently provided by the one or more external computing devices 108. For example, the one or more external computing devices 108 may be configured to perform one or more training or configuration steps/operations of the present disclosure to train or configure one or more prediction models, as described herein. In such a case, the trained/configured prediction model(s) may be provided to the predictive computing device 106, which may leverage the trained/configured prediction models to perform one or more inference steps/operations of the present disclosure. In some examples, feedback (e.g., evaluation data, ground truth data) from the use of the prediction model(s) may be received or stored by the predictive computing device 106. In some examples, the feedback may be provided to the one or more external computing devices 108 to continuously train or update the predictive model(s) over time. In some examples, the feedback may be leveraged by the predictive computing device 106 to continuously train or update one or more predictive models over time. In this manner, the computing system 101 may perform, via one or more combinations of computing devices, one or more prediction, training, configuration or any other prediction-based techniques of the present disclosure.

The client computing device 102 may include computer hardware or software configured to perform one or more functionalities associated with the client computing device 102. In some embodiments, the client computing device 102 may be a mobile device. For example, the client computing device 102 may be a mobile device that is capable of being held and transported by an operator. Example mobile devices include, but not limited to, smart phones, tablet computers, laptop computers, wearables, laptop computers, elements or devices interacting with such devices (e.g., web cams, microphones, etc.), or the like. In some embodiments, the client computing device 102 may be a device owned by or otherwise assigned to an operator, such as a personal mobile phone, tablet, laptop, desktop computer, or other related devices. In some embodiments, the client computing device 102 is an electronic computing device that may be used by an operator for any of a variety of purposes including, but not limited to, one or more of sending or receiving signals, storing data, displaying data, viewing data, transmitting data, receiving data, or the like. For example, a client computing device 102 may be capable of, but not limited to, one or more of displaying graphical user interfaces and other graphical representations on the screen of the client computing device 102, receiving user input (e.g., operator input), and/or the like.

The client computing device 102 may use (e.g., access or install) one or more computer program products (e.g., a mobile application platform, desktop computer application platform) configured to provide one or more functionalities of the client computing device 102. In some embodiments, the client computing device 102 hosts or is otherwise associated with one or more connected applications. In some embodiments, a connected application is a software application configured to provide one or more functionalities associated with strategic and tactical aircraft mission planning. For example, in some embodiments, a connected application may comprise one or more flight planning applications configured for generating flight plans and/or providing other functionalities associated with aircraft mission planning, including real-time modification of flight plans during the flight. For example, in some implementations a client computing device 102 may host one or more connected applications (e.g., one or more flight planning applications) that allow users (e.g., pilot) to perform various functions such as flight planning calculations, displaying navigation charts, displaying real-time weather information, and/or the like.

In some embodiments, the client computing device 102 may include a display component on which a graphical user interface may be rendered. In some embodiments, the predictive computing device 106 may be configured to transmit computer executable instructions configured to cause a graphical user interface to be rendered on the display component of the client computing device 102. For example, the predictive computing device 106 may be configured to command and/or control the client computing device 102 to generate a graphical user interface that includes a variety of GUI objects or elements (e.g., buttons, sliders, and the like) which may be used to prompt a user (e.g., pilot or other flight crew) to interact with the predictive computing device 106 to provide user input, and for the predictive computing device 106 to activate corresponding functions and provide user feedback, responsive to received user input at the graphical user interface element. In some embodiments, the display component may be a touch screen display.

In some embodiments, the graphical user interface rendered on the display component of the client computing device 102 may include a navigation display configured to present clear air turbulence predictions along the flight path. For example, the graphical user interface may include a Clear Air Turbulence Situational Display that visually represents turbulence intensity classifications for locations within the spatial region associated with the flight path. In some embodiments, the graphical user interface may include color-coded regions, icons, or other graphical indicators overlaid on a navigation display, wherein each graphical indicator corresponds to a location within the spatial region and visually distinguishes between turbulence intensity levels such as null, light, light-to-moderate, moderate, moderate-to-severe, severe, severe-to-extreme, or extreme. In some embodiments, the graphical user interface may be configured to present turbulence predictions at multiple flight levels simultaneously, enabling pilots to identify smoother air at higher or lower altitudes and make informed decisions about altitude changes.

In some embodiments, the graphical user interface may include one or more alert elements configured to display notifications or recommendations based on the predicted turbulence dataset. For example, for light and/or moderate turbulence intensity classifications, the graphical user interface may display a proactive alert recommending passenger notification (e.g., a "seat belt on" indicator). For severe or extreme turbulence intensity classifications, the graphical user interface may display recommendations for flight path deviations including flight level changes or lateral route modifications. In some embodiments, the graphical user interface may include interactive elements that allow the user (e.g., pilot) to select alternative flight levels or lateral deviations and view corresponding turbulence predictions for the selected alternatives.

In some embodiments, the graphical user interface may include input elements configured to receive weather data from the user. For example, the graphical user interface may include input fields or controls that allow the pilot to enter wind data and temperature data for one or more waypoints along the flight path, including wind and temperature data at lateral distances from the waypoints. In some embodiments, the graphical user interface may be configured to display the weather model data, including atmospheric data for locations defined by flight level and lateral distance from reference points along the flight path, thereby enabling the user to review and verify the input data used for generating the clear air turbulence predictions.

In some embodiments, the client computing device 102 is electronically and/or communicatively coupled to the aircraft 110, the predictive computing device 106, and/or the one or more aircraft components 104. In some embodiments, the client computing device 102 may be located remotely from the aircraft 110 (e.g., in a control tower at an airport), in proximity of the aircraft (e.g., with a pilot at an airport gate associated with the aircraft), and/or within the aircraft 110 (e.g., with the pilot in the aircraft). In some embodiments, the client computing device 102 is an electronic flight bag (EFB). In some embodiments, the client computing device 102 is configured via hardware, software, firmware, and/or a combination thereof, to perform data intake of one or more types of data. In some embodiments, the client computing device 102 is an edge device. Additionally, or alternatively, in some embodiments, the client computing device 102 is configured via hardware, software, firmware, and/or a combination thereof, to generate and/or transmit command(s) that control, adjust, or otherwise impact operations of one or more of the aircraft 110, the predictive computing device 106, and/or the one or more aircraft components 104. Additionally, or alternatively, in some embodiments, the client computing device 102 is configured via hardware, software, firmware, and/or a combination thereof, to perform data reporting, provide data, and/or other data output process(es) associated with monitoring or otherwise analyzing operations of one or more of the aircraft 110, the predictive computing device 106, and/or the one or more aircraft components 104. For example, in various embodiments, the client computing device 102 may be configured to execute and/or perform one or more operations and/or functions described herein.

In some embodiments, the one or more aircraft components 104 are electronically and/or communicatively coupled to the aircraft 110, the predictive computing device 106, and/or the client computing device 102. The one or more aircraft components 104 may be located within the aircraft 110. In this regard, for example, the one or more aircraft components 104 may be one or more individual components of the aircraft that perform a particular function during operation of the aircraft 110. For example, the one or more aircraft components 104 may include one or more of multi-function control and display units (MCDU), flight management systems (FMS), inertial reference systems (IRS), sensors, actuators, primary flight displays, radars (e.g., weather radars), engines, auxiliary power units (APU), enhanced ground proximity warning systems (EGPWS), cabin lighting, video systems, battery components, obstacle detection components, communication components, communication components, and/or the like. In this regard, for example, the individual components of the aircraft 110 may include components associated with a particular process or operation performed by the aircraft 110. The one or more aircraft components 104, for example, may be part of an avionics system of the aircraft 110 or represent an avionics system of the aircraft 110. In some embodiments, the one or more aircraft components 104 are physically secured to the aircraft 110.

In some embodiments, the one or more aircraft components 104 are configured via hardware, software, firmware, and/or a combination thereof, to perform data intake of one or more types of data. Additionally, or alternatively, in some embodiments, the one or more aircraft components 104 are configured via hardware, software, firmware, and/or a combination thereof, to generate and/or transmit command(s) that control, adjust, or otherwise impact operations of one or more of the aircraft 110, the predictive computing device 106, and/or the client computing device. Additionally, or alternatively, in some embodiments, the one or more aircraft components 104 are configured via hardware, software, firmware, and/or a combination thereof, to perform data reporting, provide data, and/or other data output process(es) associated with monitoring or otherwise analyzing operations of one or more of the aircraft 110, the predictive computing device 106, and/or the client computing device 102. For example, in various embodiments, the one or more aircraft components 104 may be configured to execute and/or perform one or more operations and/or functions described herein.

In some embodiments, the one or more aircraft components 104 includes one or more components of the computing system 101 or predictive computing device 106. For example, in some embodiments, at least a portion of the predictive computing device 106 (e.g., one or more components thereof) is embodied by a flight management system. In this regard, in such embodiments, the flight management system may include one or more components of the predictive computing device 106, such as the weather modeling module, the trajectory generator module, the CAT parameters prediction module, the CAT intensity computation module, and/or the display module. In some embodiments, the flight management system is an onboard flight management system installed within the aircraft 110. In some embodiments, the flight management system is a connected flight management system (cFMS) configured to exchange data with external computing devices, client computing devices (such as electronic flight bags), and/or cloud-based systems via secure connections in real time. In some embodiments, the predictive computing device 106 or one or more components thereof is embodied by a mission manager partition of the flight management system. The mission manager partition may be configured to perform clear air turbulence prediction operations while leveraging the trajectory computation capabilities and performance expertise of the flight management system. In some embodiments, the flight management system provides trajectory data, aircraft position data, altitude data, and timing information to the predictive computing device 106 or components thereof for use in generating clear air turbulence predictions along the flight path. In some embodiments, the flight management system receives the predicted turbulence dataset from the predictive computing device 106 and integrates the turbulence predictions with other flight management data for display on a navigation display or other suitable interface accessible to the pilot. In some embodiments, the computing system 101 or predictive computing device 106 is embodied by a portable computing device, such as an electronic flight bag, configured to perform clear air turbulence prediction computations and communicate with the flight management system and/or other aircraft components 104.

It will be understood that while many of the aspects and elements presented in FIG. 1 are shown as discrete, separate elements, other configurations may be used in connection with the methods, apparatuses, computer readable media, and computer programs described herein, including configurations that combine, omit, separate, or add aspects or elements. The various functions of the system environment 100 may be performed by other arrangements of one or more computing devices or computing systems without departing from the scope of the present disclosure. For example, in some embodiments, the functions of one or more of the illustrated elements in FIG. 1 may be performed by a single computing device or by multiple computing devices, which devices may be local or cloud based.

It will be appreciated that the various functions performed by two or more of the elements presented in FIG. 1 may be embodied by a single apparatus, subsystem, or system comprising one or more sets of computing hardware (e.g., processor(s) and memory) configured to perform various functions thereof. In some embodiments, one or more intermediary devices may be positioned in electrical communication between the depicted system elements (e.g., connection between computing devices may be facilitated by various intermediary networking hardware or software elements).

In some embodiments, two or more of the elements in FIG. 1 may be part of a single system or device. In some embodiments, two or more of the depicted elements in FIG. 1 may be physically or electronically remote from each other (e.g., connected via the Internet). For example, the client computing device 102 and predictive computing device 106 may be part of the same local networked system or part of the same computing system (e.g., predictive computing device 106 may be a terminal or other front end portion associated with the computing system 101 or a larger system that includes both the predictive computing device 106 and the client computing device 102). In some embodiments, two or more of the depicted devices or computing systems may be physically or electronically remote from each other (e.g., connected via the Internet).

In some embodiments, two or more of computing system 101, the predictive computing device 106, client computing device(s) 102, or external computing device(s) 108 may be embodied by a flight management system (FMS). For example, in some embodiments, the computing system 101 (or one or more components thereof) is embodied by an FMS. In one example embodiment, the computing system 101 or two or more of the predictive computing device 106, client computing device(s) 102, or external computing device(s) 108 is embodied by a mission manager partition of an FMS. In some embodiments, the FMS is an onboard FMS such as, for example, an FMS onboard an aircraft. In some embodiments, the FMS is a connected FMS. An FMS system may be capable of exchanging data with client computing devices, such as electronic flight bags (EFBs) via a secure connection in real time, which allows for real time updates (e.g., flight plans, weather data, or the like).

The various elements illustrated in the system environment 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software or firmware required to implement it (such as, e.g., network routers, etc.). For example, the network may include a cellular telephone, an 802.11, 802.16, 802.20, or WiMAX network. Further, a network may include a public network, such as the Internet, a private network, such as an intranet, or combinations thereof, and may utilize a variety of networking protocols now available or later developed including, but not limited to TCP/IP based networking protocols.

In various embodiments, the elements depicted in FIG. 1 as being included in the computing system 101, the predictive computing device 106, the aircraft 110, the client computing device 102, aircraft components 104, or external computing devices 108, although not required to be an integral system, may be connected via one or more networks. In some embodiments, one or more APIs may be leveraged to communicate with or facilitate communication between one or more of the elements illustrated in the computing system 101, the predictive computing device 106, the aircraft 110, the client computing device 102, aircraft components 104, external computing devices 108, or system environment 100.

Having discussed example systems in accordance with the present disclosure, example apparatuses in accordance with the present disclosure will now be described.

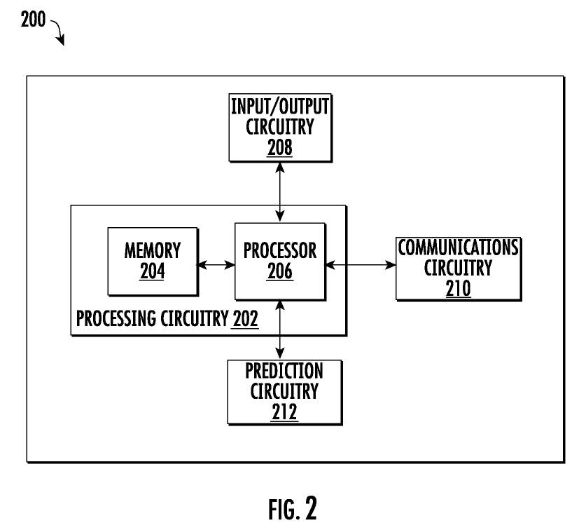

FIG. 2 illustrates a block diagram of an apparatus 200 in accordance with some example embodiments. For example, in some embodiments, the computing system 101 may be embodied by one or more apparatuses 200. In this regard, in some embodiments, the computing system 101 or one or more portions (e.g., one or more individual elements) thereof, if embodied in a particular embodiment, may be embodied by one or more apparatuses 200.

In some embodiments, the apparatus 200 may include a processing circuitry 202 as shown in FIG. 2. In some embodiments, the elements illustrated in and described with reference to FIG. 2 below may not be mandatory and thus one or more may be omitted in certain embodiments. Additionally, some embodiments, may include further or different elements beyond those illustrated in and described with reference to FIG. 2. In some embodiments, the functionality of the computing system 101 or any subset thereof may be performed by a single apparatus 200 or multiple apparatuses 200. In some embodiments, the apparatus 200 may comprise one or a plurality of physical devices, including distributed, cloud-based, or local devices.

Although some elements are described with respect to functional limitations, it should be understood that the particular implementations necessarily include the use of particular computing hardware, such as the hardware shown in FIG. 2. It should also be understood that certain of the elements described herein may include similar or common hardware. For example, two sets of circuitries for example, may both leverage use of the same processor(s), network interface(s), storage medium(s), or the like, to perform their associated functions, such that duplicate hardware is not required for each set of circuitry and a single physical circuitry may be used to perform the functions of multiple circuitries described herein. The use of the term “circuitry” as used herein with respect to elements of the apparatuses described herein should therefore be understood to include particular hardware configured to perform the functions associated with the particular circuitry as described herein.

In some embodiments, “circuitry” may include processing circuitry, storage media, network interfaces, input/output devices, or the like. In some embodiments, other elements of the apparatus 200 may provide or supplement the functionality of another particular set of circuitry. For example, the processor 206 in some embodiments provides processing functionality to any of the sets of circuitries, the memory 204 provides storage functionality to any of the sets of circuitry, the communications circuitry 210 provide network interface functionality to any of the sets of circuitry, or the like.

The apparatus 200 may include or otherwise be in communication with processing circuitry 202 that is configurable to perform actions in accordance with one or more example embodiments disclosed herein. In this regard, the processing circuitry 202 may be configured to perform or control performance of one or more functionalities of the apparatus 200 in accordance with various example embodiments, and thus may provide means for performing functionalities of the apparatus 200 in accordance with various example embodiments. The processing circuitry 202 may be configured to perform data processing, application, and function execution, or other processing and management services according to one or more example embodiments. In some embodiments, the apparatus 200 or a portion(s) or elements(s) thereof, such as the processing circuitry 202, may be embodied as or comprise a chip or chip set. In other words, apparatus 200 or the processing circuitry 202 may comprise one or more physical packages (e.g., chips) including materials, elements or wires on a structural assembly (e.g., a baseboard). The structural assembly may provide physical strength, conservation of size, or limitation of electrical interaction for element circuitry included thereon. The apparatus 200 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some embodiments, the processing circuitry 202 may include a processor 206 (or co-processor or any other processing circuitry assisting or otherwise associated with the processor) and, in some embodiments, such as that illustrated in FIG. 2, may further include memory 204. The processing circuitry 202 may be in communication with or otherwise control a user interface (e.g., embodied by input/output circuitry 208) or a communications circuitry 210. As such, the processing circuitry 202 may be embodied as a circuit chip (e.g., an integrated circuit chip) configured (e.g., with hardware, software or a combination of hardware and software) to perform operations described herein.

The processor 206 may be embodied in a number of different ways. For example, the processor 206 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 206 may comprise a plurality of processors. The plurality of processors may be in operative communication with each other and may be collectively configured to perform one or more functionalities of the apparatus 200 as described herein. In some example embodiments, the processor 206 may be configured to execute instructions stored in the memory 204 or otherwise accessible to the processor 206. As such, whether configured by hardware or by a combination of hardware and software, the processor 206 may represent an entity (e.g., physically embodied in circuitry – in the form of processing circuitry 202) capable of performing operations according to embodiments of the present disclosure while configured accordingly. Thus, for example, when the processor 206 is embodied as an ASIC, FPGA or the like, the processor 206 may be specifically configured hardware for conducting the operations described herein. Alternatively, as another example, when the processor 206 is embodied as an executor of software instructions, the instructions may specifically configure the processor 206 to perform one or more operations described herein. The use of the terms “processor” and “processing circuitry” may be understood to include a single core processor, a multi-core processor, multiple processors internal to the apparatus 200, or one or more remote or “cloud” processor(s) external to the apparatus 200.

In some example embodiments, the memory 204 may include one or more non-transitory memory devices such as, for example, volatile or non-volatile memory that may be either fixed or removable. In this regard, the memory 204 may comprise a non-transitory computer-readable storage medium. It will be appreciated that while the memory 204 is illustrated as a single memory, the memory 204 may comprise a plurality of memories. The memory 204 may be configured to store information, data, applications, instructions or the like for enabling the apparatus 200 to carry out various functions in accordance with one or more example embodiments. For example, the memory 204 may be configured to buffer input data for processing by the processor 206. Additionally, or alternatively, the memory 204 may be configured to store instructions for execution by the processor 206. The memory 204 may include one or more databases that may store a variety of files, contents, or data sets. Among the contents of the memory 204, applications may be stored for execution by the processor 206 in order to carry out the functionality associated with each respective application. In some cases, the memory 204 may be in communication with one or more of the processors 206, input/output circuitry 208 or communications circuitry 210, via a bus(es) for passing information among elements of the apparatus 200.

The input/output circuitry 208 may provide output to the user or an intermediary device and, in some embodiments, may receive one or more indication(s) of user input directly or indirectly. In some embodiments, the input/output circuitry 208 is in communication with processor 206 to provide such functionality. The input/output circuitry 208 may include one or more user interface(s) or include a display that may comprise the user interface(s) rendered as a web user interface, an application interface, or the like, to the display of a client computing device, a backend system, or the like. The input/output circuitry 208 may be in communication with the processing circuitry 202 to receive an indication of a user input at the user interface or to provide an audible, visual, mechanical, or other output to the user. As such, the input/output circuitry 208 may include, for example, a keyboard, a mouse, a joystick, a display, a touch screen display, a microphone, a speaker, or other input/output mechanisms. As such, the input/output circuitry 208 may, in some example embodiments, provide means for a user to access and interact with the apparatus 200. The processor 206 or input/output circuitry 208 comprising or otherwise interacting with the processor 206 may be configured to control one or more functions of one or more user interface elements through computer program instructions (e.g., software or firmware) stored on a memory accessible to the processor 206 (e.g., stored on memory 204, or the like).

The communications circuitry 210 may include one or more interface mechanisms for enabling communication with other devices or networks. In some cases, the communications circuitry 210 may comprise any means such as a device or circuitry embodied in either hardware, or a combination of hardware and software that is configured to receive or transmit data from/to a network or any other device or module in communication with the processing circuitry 202. The communications circuitry 210 may, for example, include an antenna (or multiple antennas) and supporting hardware or software for enabling communications with a wireless communication network (e.g., a wireless local area network, cellular network, global positioning system network, or the like) or a communication modem or other hardware/software for supporting communication via cable, digital subscriber line (DSL), universal serial bus (USB), Ethernet or other methods.

In some embodiments, the apparatus 200 may include a prediction circuitry 212 which may include hardware elements, with or without enabling software elements, firmware elements, or a combination thereof configured to, with the processing circuitry 202, input/output circuitry 208 or communications circuitry 210, perform one or more functions associated with the predictive computing device 106 (as described above with reference to FIG. 1). For example, the prediction circuitry 212 may access, facilitate access, receive, process, manipulate, provide, or otherwise use, or make available for use, certain data (e.g., wind data, pressure data, temperature data, or other data) used by one or more other elements of the apparatus 200 through, for example, the use of hardware, software, applications, or APIs executed using a processor, such as the processor 206. In some embodiments, the prediction circuitry 212 may interact with the memory 204, which may store the aforementioned data. It should also be appreciated that, in some embodiments, the prediction circuitry 212 may include a separate processor, specially configured field programmable gate array (FPGA), or application specific interface circuit (ASIC) to receive such data utilized by the prediction circuitry 212. The prediction circuitry 212 may also provide for communication with other elements of the apparatus 200, system or external systems via a network interface provided by the communications circuitry 210. In some embodiments, one or more portions of the prediction circuitry 212 and processing circuitry 202 may be integrated into a single circuitry or group of circuitries, with or without various other circuitries discussed herein, configured to execute the respective functionalities thereof.

The prediction circuitry 212 may include software or a combination of hardware and software that supports various functionality associated with one or more prediction models. For example, in some embodiments, the prediction circuitry 212 includes hardware, software, firmware, or a combination thereof, that performs predictive data analysis to generate a predicted turbulence dataset for a spatial region associated with a flight for an aircraft by utilizing one or more prediction models. The one or more prediction models may be trained or configured to perform such predictive data analysis using input dataset comprising wind data and/or temperature data as describe herein.

In this regard, FIG. 1 shows an example system environment 100 within which at least some embodiments of the present disclosure, including apparatus(es) 200, may operate. The depictions of the example system environment 100 and apparatus 200 are not intended to limit or otherwise confine the embodiments described and contemplated herein to any particular configuration of elements or systems, nor are they intended to exclude any alternative configurations or systems for the set of configurations and systems that can be used in connection with embodiments of the present disclosure. Rather, FIGS. 1-2 and the system environment 100 and apparatus(es) 200 disclosed therein are merely presented to provide an example basis and context for the facilitation of some of the features, aspects, and uses of the methods, apparatuses, computer readable media, and computer program products disclosed and contemplated herein. As noted above, in some embodiments, the predictive computing device 106 may be embodied by one or more apparatuses 200 shown in FIG. 2 or portions thereof relevant to the functions of the respective devices.

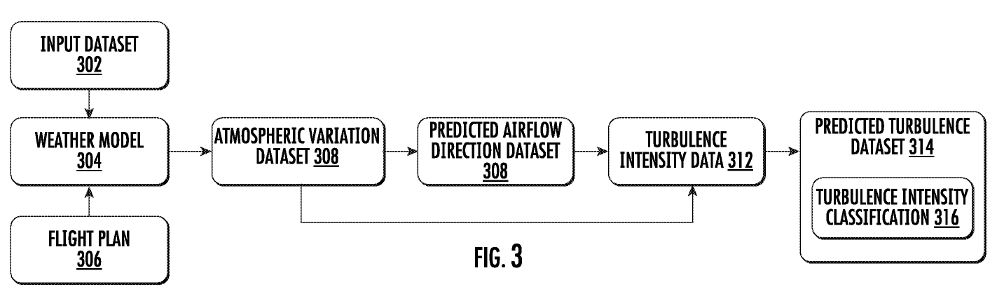

Referring to FIG. 3, a visualization of an example data environment for generating clear air turbulence predictions in accordance with at least one example embodiment of the present disclosure is provided. Using the various elements and techniques described herein, the computing system 101 (e.g., predictive computing device 106 thereof) may be configured to execute a clear air turbulence prediction process configured to generate predicted turbulence dataset 314 indicative of predicted turbulence within a spatial region associated with an aircraft, and initiate performance of one more prediction-based actions based at least in part on the predicted turbulence dataset 314.

In some embodiments, the computing system 101 receives an input dataset 302 for a flight by an aircraft. In some embodiments, the computing system 101 receives the input dataset 302 from external computing device(s) 108, client computing device(s) 102, and/or aircraft component(s) 104. For example, the input dataset 302 may be received from onboard sensors that measure current atmospheric conditions at the aircraft location, pilot-entered data input via a flight management system interface, uplinked data received from ground-based systems or air traffic control, and/or network weather data obtained from connected aircraft systems or cloud-based weather services.

In some embodiments, the input dataset 302 comprises wind data. The wind data may comprise measured wind metrics for one or more locations within a spatial region associated with the flight path. For example, the wind data may include wind speed and wind direction measurements at various waypoints along the flight path and at different flight levels. Additionally, the wind data may include wind measurements at lateral distances from the waypoints, such as at a predetermined distance to the left and right of each waypoint along the route. Alternatively, or additionally, in some embodiments, the input dataset 302 comprises temperature data. The temperature data may comprise measured temperature values for the one or more locations within the spatial region, wherein each location is defined by a flight level and lateral distance from a reference location along the flight path. For example, the temperature data may include temperature measurements at various altitudes (flight levels) and at lateral offsets from waypoints along the planned route.

In some embodiments, the computing system 101 generates a weather model 304 for a spatial region associated with the flight based on the input dataset 302 and a flight plan 306 that identifies a flight path for the aircraft. The flight plan 306 may define a series of waypoints, route segments, and associated flight levels that the aircraft is planned to traverse during the flight. In some embodiments, the computing system 101 leverages the flight plan 306 to identify reference points (e.g., waypoints) along the flight path for which atmospheric data should be obtained or computed. The weather model 304 may be generated by correlating the wind data and temperature data from the input dataset 302 with the geographic locations and flight levels defined by the flight plan 306. In some embodiments, the computing system 101 generates the weather model 304 by associating atmospheric data with each of a plurality of computation points within the spatial region, wherein the computation points are determined based on the flight path defined by the flight plan 306 and extend laterally from the flight path up to a predetermined distance (e.g., approximately 25 nautical miles) on either side of the route. The weather model 304 may further define computation points at multiple flight levels, including the planned flight level and alternative flight levels above and below the planned flight level, thereby enabling comprehensive atmospheric parameter computation across a three-dimensional spatial region surrounding the flight path. In some embodiments, the computing system 101 updates the weather model 304 dynamically as new input data becomes available or as the flight plan 306 is modified during the flight, thereby enabling real-time clear air turbulence predictions that reflect current atmospheric conditions and planned route changes.

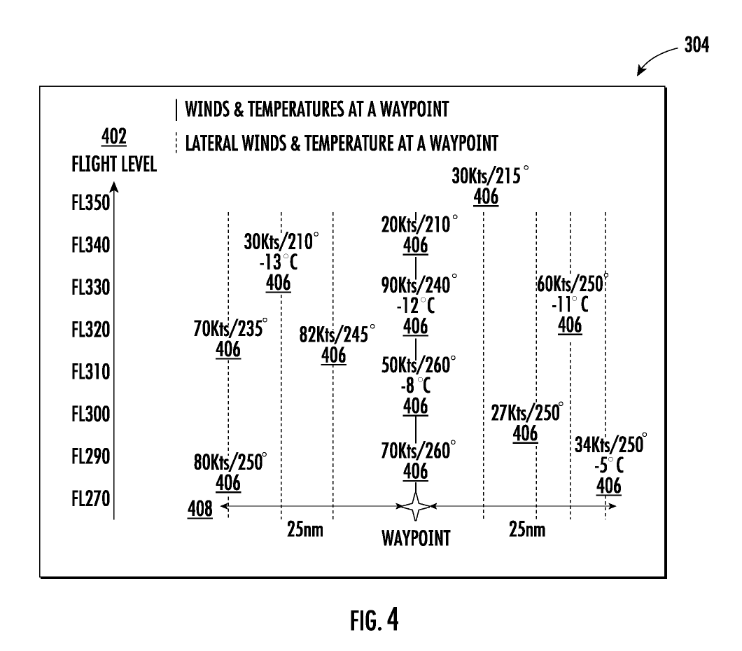

Now referencing FIG. 4, an example weather model 304 for a spatial region in accordance with at least one example embodiment of the present disclosure. As illustrated in FIG. 4, the spatial region may be associated with a reference point 404 (e.g., waypoint) along the flight path. For example, the flight may be associated with a plurality of reference points 404, wherein each reference point 404 defines, or otherwise is associated with, a particular spatial region. In this regard, FIG. 4 illustrates a weather model 304 associated with a particular reference point 404 in accordance with at least one example embodiment of the present disclosure.

Reference points (e.g., waypoints) along the flight path may comprise predetermined geographical positions used to define the flight path. Reference points may serve as navigation guides during the flight to, for example, ensure that the aircraft follows the flight path. In some embodiments, reference points may be defined by geographic coordinates (e.g., latitude and longitude), navigational aids (e.g., VOR stations, NDB beacons, or the like), or intersection points defined by radials from multiple navigational aids. Reference points may be associated with specific flight levels, altitudes, or altitude constraints that the aircraft is expected to maintain when passing through or near the reference point. In some embodiments, reference points may include departure waypoints, en route waypoints, arrival waypoints, approach waypoints, or any combination thereof, depending on the phase of flight and the structure of the flight plan. Reference points may be entered by a pilot via a flight management system interface, received via uplink from air traffic control or ground-based systems, or retrieved from a navigation database stored onboard the aircraft. In some embodiments, reference points serve as anchor locations for the weather model, wherein atmospheric data (e.g., wind data, temperature data, pressure data, or the like) is associated with each reference point and with locations defined relative to each reference point in both the longitudinal direction (e.g., along the flight path) and the lateral direction (e.g., perpendicular to the flight path). The use of reference points enables the computing system 101 (e.g., predictive computing device 106 thereof) to organize and correlate atmospheric data across the spatial region in a structured manner that aligns with the planned flight path, thereby facilitating accurate clear air turbulence predictions for locations along and around the aircraft route.

In some embodiments, the weather model 304 defines one or more locations within the spatial region relative to the reference point 404 and corresponding atmospheric data 406 for each defined location (also referred to herein as computation point). In some embodiments, the one or more locations comprise a plurality of defined locations (computation points). As illustrated, in some embodiments, the weather model 304 may define the location(s) (computation point(s)) proximate to and/or around the reference point 404 in a longitudinal direction and lateral direction. For example, the weather model 304 may define a longitudinal axis 402 representative of flight levels and lateral axis 408 representative of lateral distances (e.g., left or right) relative to the reference point 404. Each defined location within the spatial region may be defined by (or otherwise correspond to) a flight level (e.g., altitude) and lateral distance from the reference point (waypoint). In some embodiments, the spatial region extends laterally from the reference point 404 up to a predetermined distance (such as approximately 25 nautical miles in some examples) on either side of the reference point, that represents an operationally safe deviation distance from the route. In some embodiments, the spatial region further extend vertically across multiple flight levels, including at the aircraft flight level and at flight levels above and below the aircraft flight level (e.g., at 50 feet below and 50 feet above the aircraft flight level in some examples), thereby enabling the computing system 101 or predictive computing device 106 to evaluate atmospheric conditions across both a lateral and vertical range of the spatial region. In this manner, the weather model 304 defines a three-dimensional grid of computation points surrounding the flight path, wherein each computation point is associated with specific atmospheric data 406 that may be leveraged to generate clear air turbulence predictions for the corresponding location within the spatial region.

In some embodiments, the atmospheric data 406 comprises data for one or more atmospheric parameters such as wind, temperature, pressure, density, and/or the like. In some embodiments, the atmospheric data 406 comprises wind data. The wind data may include wind speed measurements and wind direction measurements for each defined location within the spatial region. Alternatively or additionally, in some embodiments, the atmospheric data 406 comprises temperature data. The temperature data may include measured temperature values that enable computation of temperature gradients across the spatial region, wherein temperature gradients represent the change of temperature over a distance in a given direction. In this regard, in some embodiments, each defined location may be associated with atmospheric data 406 comprising wind data and/or temperature data associated with the respective defined location. For example, in some embodiments, the weather model 304 comprises wind data (e.g., measured wind metric) and/or temperature data along a flight path for an aircraft at one or more locations, wherein each location is defined by a flight level and lateral distance relative to the reference point 404. In some embodiments, the atmospheric data 406 further comprises pressure data and/or density data that may be computed or derived based on the wind data and temperature data using known physical relationships between these atmospheric parameters. For example, the computing system 101 (e.g., predictive computing device 106 thereof) may compute pressure and density values for each defined location based on the temperature data and standard atmospheric models, leveraging the physical phenomena wherein where the temperature of a gas changes, so does its density, and where the density changes, clear air turbulence can appear. In some embodiments, the atmospheric data 406 for each defined location enables the one or more prediction models to identify regions where air density is significantly different due to temperature gradients, particularly at the tropopause, where clear air turbulence is more likely to occur. The atmospheric data 406 may be obtained from multiple sources including onboard sensors that measure current atmospheric conditions at the aircraft location, pilot-entered data input via a flight management system interface, uplinked data received from ground-based systems or air traffic control, and network weather data obtained from connected aircraft systems or cloud-based weather services.

Returning to FIG. 3, in some embodiments, the computing system 101 generates predicted turbulence dataset 314 associated with the spatial region. In some embodiments, the predicted turbulence dataset 314 in indicative and/or representative of predicted clear air turbulence turbulence for one or more defined locations within the spatial region. In some embodiments, the computing system 101 generates the predicted turbulence dataset 314 by applying the set of atmospheric data 406 defined by the weather model 304 to one or more prediction models.

In some embodiments, the computing system 101, using the one or more prediction models, generates atmospheric variation dataset 308 based on the set of atmospheric data 406. For example, in some embodiments, the one or more prediction models is configured to generate the atmospheric variation dataset 308 based on the wind data and/or temperature data associated with locations (computation points) defined by the weather model

In some embodiments, the atmospheric variation dataset 308 may comprise computed atmospheric parameters that characterize the atmospheric conditions at each computation point within the spatial region. The atmospheric variation dataset 308 may include data indicative of changes in atmospheric properties across the spatial region, wherein such changes may be leveraged by the one or more prediction models to identify conditions conducive to clear air turbulence formation. In some embodiments, the one or more prediction models computes the atmospheric variation dataset 308 by analyzing the relationships between pressure, density, and temperature at each computation point, The atmospheric variation dataset 308 may be computed for computation points extending laterally from the flight path up to a predetermined distance (such as approximately 25 nautical miles) on either side of the route, which represents an operationally safe deviation distance from the route. In some embodiments, the atmospheric variation dataset 308 is further computed at multiple flight levels, including at the aircraft flight level and at flight levels above and below the aircraft flight level (e.g., at approximately 50 feet below and approximately 50 feet above the aircraft flight level), thereby enabling comprehensive evaluation of atmospheric conditions across both a lateral and vertical range of the spatial region.

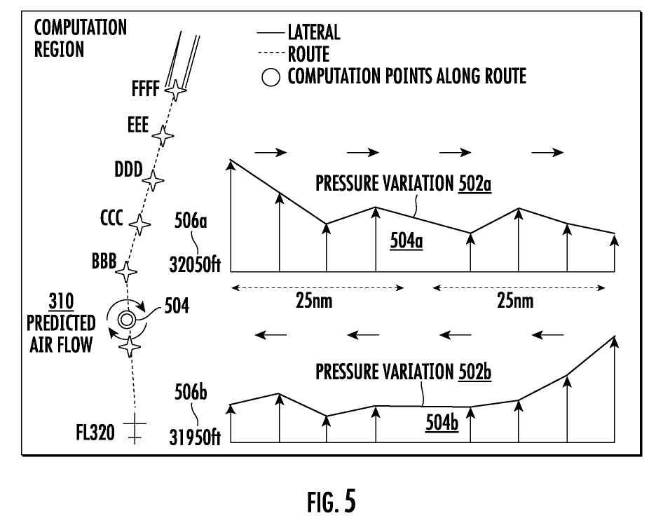

In some embodiments, the atmospheric variation dataset 308 comprises pressure variation data associated with the spatial region, representative and/or indicative of pressure variation associated with the spatial region. Referring now to FIG. 5, which illustrates a visualization of an example pressure variation associated with a spatial region in accordance with at least on example embodiment of the present disclosure. In particular, FIG. 5 depicts computed pressure variations 502 at 50ft below and above aircraft flight level in two different lateral directions from a point of interest (computation point 504). In this regard, the one or more prediction models may be configured to generate at least a portion of the atmospheric variation dataset 308 (e.g., pressure variation data thereof) by computing pressure data for each of one or more defined locations within the spatial region based on the atmospheric data 406 (e.g., wind data, temperature data, and/or the like) for the respective computation point. The one or more prediction models may leverage the physical relationship between pressure, density, and temperature to compute pressure values at each computation point.

In some embodiments, the one or more prediction models computes pressure data at multiple flight levels, including at the aircraft flight level and at flight levels above and below the aircraft flight level (e.g., at approximately 50 feet below and approximately 50 feet above the aircraft flight level), to identify pressure variations across a vertical range of the spatial region. For example, as shown in FIG. 5, a first atmospheric variation data from the atmospheric variation dataset 308 may comprise pressure variation 502a associated with a computation point 504a at a first flight level 506a across the lateral direction corresponding to the first flight level 506a. As depicted, the first flight level 506a may correspond to a flight level above the aircraft flight level, such as approximately 50 feet above the current aircraft altitude. As another example, a second atmospheric variation data may comprise pressure variation 502b associated with a second computation point 504b at a second flight level 506b across the lateral direction corresponding to the second flight level 506b. As depicted, the second flight level 506b may correspond to a flight level below the aircraft flight level, such as approximately 50 feet below the current aircraft altitude. The pressure variations 502a and 502b are computed in two different lateral directions from the respective computation points 504a and 504b, thereby enabling the one or more prediction models to identify directional differences in pressure variations that may indicate potential vortices or air pockets. For example, where pressure variations indicate air flowing from high pressure to low pressure in different directions at a computation point, the directional difference in pressure variations may lead to potential vortices or air pockets at that computation point, which may be indicative of clear air turbulence.

Returning to FIG. 3, in some embodiments, the atmospheric variation dataset 308 further comprises density variation data computed based on the temperature data and pressure data, leveraging the physical phenomena wherein where the temperature of a gas changes, so does its density. the one or more prediction models may compute density values for each computation point within the spatial region and identify regions where air density is significantly different due to temperature gradients, particularly at the tropopause, where clear air turbulence is more likely to occur. In some embodiments, the atmospheric variation dataset 308 is computed for computation points extending laterally from the flight path up to a predetermined distance (such as approximately 25 nautical miles or other distance) on either side of the route.

In some embodiments, the atmospheric variation dataset 308 comprises temperature variation data. Temperature variation data may include computed or measured differences in temperature values across the spatial region, wherein temperature variations represent the change of temperature over a distance in a given direction (i.e., temperature gradients). In this regard, in some embodiments, the computing system 101, using the one or more prediction models, may be configured to calculate/compute pressure variation and/or temperature variation within the spatial region. For example, the one or more prediction models may compute temperature values at each of the one or more defined locations (computation points) within the spatial region and determine temperature variations by comparing temperature values between adjacent or proximate computation points. The temperature variation data may be computed at multiple flight levels, including at the aircraft flight level and at flight levels above and below the aircraft flight level (e.g., at approximately 50 feet below and approximately 50 feet above the aircraft flight level in some examples), to identify temperature gradients across a vertical range of the spatial region. In some embodiments, the one or more prediction models leverages the physical phenomena wherein where the temperature of a gas changes, so does its density, and where the density changes, clear air turbulence can appear. Accordingly, the temperature variation data enables the one or more prediction models to identify regions where air density is significantly different due to temperature gradients, particularly at the tropopause, where clear air turbulence is more likely to occur. In some embodiments, the temperature variation data is computed for computation points extending laterally from the flight path up to a predetermined distance (such as approximately 25 nautical miles or other distance) on either side of the route, which represents an operationally safe deviation distance from the route. The temperature variation data may be used in conjunction with the pressure variation data to estimate air stream directions and identify potential vortices or air pockets that may be indicative of clear air turbulence conditions within the spatial region.

In some embodiments, the computing system 101, using the one or more prediction models, generates predicted airflow direction data 310 based on the set of atmospheric data 406. For example, in some embodiments, the one or more prediction model sis configured to generate the predicted airflow direction data 310 based on the wind data and/or temperature data associated with locations defined by the weather model 304. the one or more prediction models may leverage the physical principle that air flows from regions of high pressure to regions of low pressure to determine the direction of air movement at each computation point within the spatial region. In some embodiments, the computing system 101, using the one or more prediction models, generates predicted airflow direction data 310 based on the atmospheric variation dataset 308. For example, in some embodiments, the one or more prediction models may be configured to generate the predicted airflow direction data 310 based on pressure variation data and/or temperature variation data. the one or more prediction models may analyze pressure gradients between adjacent computation points to determine the direction and magnitude of airflow, wherein steeper pressure gradients may indicate stronger air movement in a particular direction. In some embodiments, the one or more prediction models computes predicted airflow direction data 310 at multiple flight levels, including at the aircraft flight level and at flight levels above and below the aircraft flight level, to identify airflow patterns across a vertical range of the spatial region. the one or more prediction models may further analyze directional differences in airflow at a given computation point, wherein air flowing from high pressure to low pressure in different directions at the same computation point may indicate potential vortices or air pockets that are characteristic of clear air turbulence conditions. For example, where pressure variations indicate converging or diverging air streams at a computation point, the directional difference in pressure variations may lead to potential vortices or air pockets at that computation point, which may be indicative of clear air turbulence. In some embodiments, the computing system 101, using the one or more prediction models, generates predicted airflow direction data 310 based on the set of atmospheric data 406 and/or atmospheric variation dataset 308. The predicted airflow direction data 310 may be computed for computation points extending laterally from the flight path up to a predetermined distance (such as approximately 25 nautical miles) on either side of the route, which represents an operationally safe deviation distance from the route.

In some embodiments, the predicted airflow direction data 310 comprises one or more items of data indicative and/or representative of the direction of air flow associated with the spatial region or one or more locations therein. For example, as shown in FIG. 5, the predicted airflow direction data 310 may comprise one or more items of data indicative and/or representative of direction of air flow associated with a particular computation point 504 (e.g., computation point 504a, 504b). The predicted airflow direction data 310 may indicate the direction in which air is moving at each computation point based on the pressure gradients computed from the atmospheric variation dataset 308. In some embodiments, the predicted airflow direction data 310 leverages the physical principle that air flows from regions of high pressure to regions of low pressure, such that the direction of air flow at a given computation point may be determined by analyzing the pressure differential between the computation point and adjacent computation points within the spatial region. The predicted airflow direction data 310 may further indicate the magnitude or strength of the air flow based on the steepness of the pressure gradient, wherein steeper pressure gradients may correspond to stronger air movement in a particular direction. In some embodiments, the predicted airflow direction data 310 includes directional vectors or other representations that characterize both the direction and relative intensity of air movement at each computation point. the one or more prediction models may analyze the predicted airflow direction data 310 to identify locations where air streams converge, diverge, or exhibit directional differences that may indicate potential vortices or air pockets characteristic of clear air turbulence conditions. For example, where the predicted airflow direction data 310 indicates that air is flowing from high pressure to low pressure in different directions at the same computation point, such directional differences may lead to potential vortices or air pockets at that computation point, which may be indicative of clear air turbulence.

In some embodiments, the one or more prediction models is configured to generate turbulence intensity data 312 for the spatial region based on atmospheric variation dataset 308 and/or predicted airflow direction data 310. In some embodiments, the turbulence intensity data 312 comprises computed turbulence intensity for each of one or more defined locations within the spatial region. In some embodiments, the turbulence intensity data 312 may be computed using one or more algorithms defined by or otherwise leveraged by the one or more prediction models.

In some embodiments, one or more prediction models is configured to generate turbulence intensity data 312 for the spatial region based on the atmospheric variation dataset 308 and/or predicted airflow direction data 310. In some embodiments, the turbulence intensity data 312 comprises computed turbulence intensity for each of one or more defined locations within the spatial region. In some embodiments, the turbulence intensity data 312 may be computed using one or more algorithms defined by or otherwise leveraged by the one or more prediction models.

In some embodiments, the one or more prediction models leverages the relationship between root mean-square vertical acceleration of the aircraft in turbulence and the cube-root of the EDR to compute turbulence intensity values. For example, the one or more prediction models may compute EDR values based on the atmospheric variation dataset 308, including pressure variation data and temperature variation data, and aircraft-specific parameters such as aircraft weight, airspeed, and altitude. In some embodiments, the one or more prediction models applies one or more physics-based algorithms that model physical phenomena relating pressure, temperature, and/or density.

In some embodiments, the one or more prediction models computes turbulence intensity data 312 by analyzing directional differences in pressure variations at computation points within the spatial region. For example, where the atmospheric variation dataset 308 indicates that pressure variations at a computation point result in air flowing from high pressure to low pressure in different directions, the one or more prediction models may determine that such directional differences lead to potential vortices or air pockets at that computation point, which may be indicative of clear air turbulence. The one or more prediction models may quantify the magnitude of such directional differences and correlate them with turbulence intensity values based on established relationships between atmospheric instability and turbulence severity.

In some embodiments, the one or more prediction models computes turbulence intensity data 312 at multiple flight levels within the spatial region, including at the aircraft flight level and at flight levels above and below the aircraft flight level (e.g., at approximately 50 feet below and approximately 50 feet above the aircraft flight level in some examples), thereby enabling identification of turbulence conditions across a vertical range of the spatial region. The one or more prediction model may further compute turbulence intensity data 312 for computation points extending laterally from the flight path up to a predetermined distance (such as approximately 25 nautical miles in some examples) on either side of the route.

In some embodiments, the one or more prediction models is implemented using one or more machine learning algorithms, statistical models, physics-based algorithms, or combinations thereof configured to process the atmospheric variation dataset 308 and/or predicted airflow direction data 310 and generate turbulence intensity predictions for locations along and around the aircraft flight path. The one or more prediction models may be trained or configured using historical turbulence data, atmospheric measurement data, and/or pilot reports of turbulence encounters to improve the accuracy of turbulence intensity predictions. In some embodiments, the one or more prediction models may be updated or fine-tuned over time based on feedback data comprising actual turbulence encounters experienced by aircraft, thereby enabling continuous improvement of prediction accuracy.

In some embodiments, the predicted turbulence dataset 314 comprises a turbulence intensity classification 316 corresponding to one or more locations within the spatial region based on the turbulence intensity data 312. For example, in some embodiments, turbulence intensity may be determined based on EDR value as either light, moderate, severe, or extreme. In some embodiments, the turbulence intensity classification 316 may include additional granularity, such as null, light, light-to-moderate, moderate, moderate-to-severe, severe, severe-to-extreme, or extreme classifications. In some embodiments, the one or more prediction models may leverage established relationships between EDR values and turbulence intensity classifications, In some embodiments, the one or more prediction models computes EDR values based on the atmospheric variation dataset 308 and aircraft-specific parameters such as aircraft weight, airspeed, and altitude, leveraging the relationship wherein the root mean-square vertical acceleration of the aircraft in turbulence is proportional to the cube-root of the EDR. The turbulence intensity classification 316 may be computed for each of the one or more defined locations (computation points) within the spatial region, thereby enabling the computing system 101 to generate a comprehensive map of turbulence conditions along and around the aircraft flight path. In some embodiments, the turbulence intensity classification 316 enables operators (e.g., pilots, air traffic controllers, or the like) to make informed decisions regarding flight path modifications, altitude changes, or passenger notifications based on the predicted severity of clear air turbulence at various locations within the spatial region.

In some embodiments, the computing system 101 initiates performance of one or more prediction-based actions based at least in part on the predicted turbulence dataset 314. In some embodiments, initiating the performance of the one or more prediction-based actions comprises generating a representation of the predicted turbulence dataset and causing display of the representation of the predicted turbulence dataset on a display of a client computing device 102. In some embodiments, initiating the performance of the one or more prediction-based actions comprises controlling one or more physical components of the aircraft based on the predicted turbulence dataset. For example, the computing system 101 may be configured to generate and transmit control signals to one or more aircraft components 104 to adjust aircraft operations in response to predicted clear air turbulence conditions.

In some embodiments, initiating the performance of the one or more prediction-based actions comprises generating and transmitting an alert to one or more client computing devices. For example, where the turbulence intensity classification indicates light or moderate turbulence, the computing system 101 may generate an alert recommending passenger notification (e.g., a "seat belt on" indicator) for display on a client computing device 102 associated with a pilot or flight crew member. In some embodiments, where the turbulence intensity classification indicates severe or extreme turbulence, the computing system 101 may generate recommendations for flight path deviations including flight level changes or lateral route modifications. In some embodiments, initiating the performance of the one or more prediction-based actions comprises transmitting the predicted turbulence dataset or a portion thereof to one or more external computing devices 108, such as air traffic control systems, ground-based flight operations centers, or connected aircraft systems associated with other aircraft operating in the same airspace.

In some embodiments, initiating the performance of the one or more prediction-based actions comprises storing the predicted turbulence dataset in a repository for subsequent analysis, model training, or historical record keeping. In some embodiments, initiating the performance of the one or more prediction-based actions comprises automatically adjusting the flight plan 306 based on the predicted turbulence dataset, wherein the computing system 101 may compute alternative flight paths or altitude profiles that avoid or minimize exposure to predicted clear air turbulence regions within the spatial region.

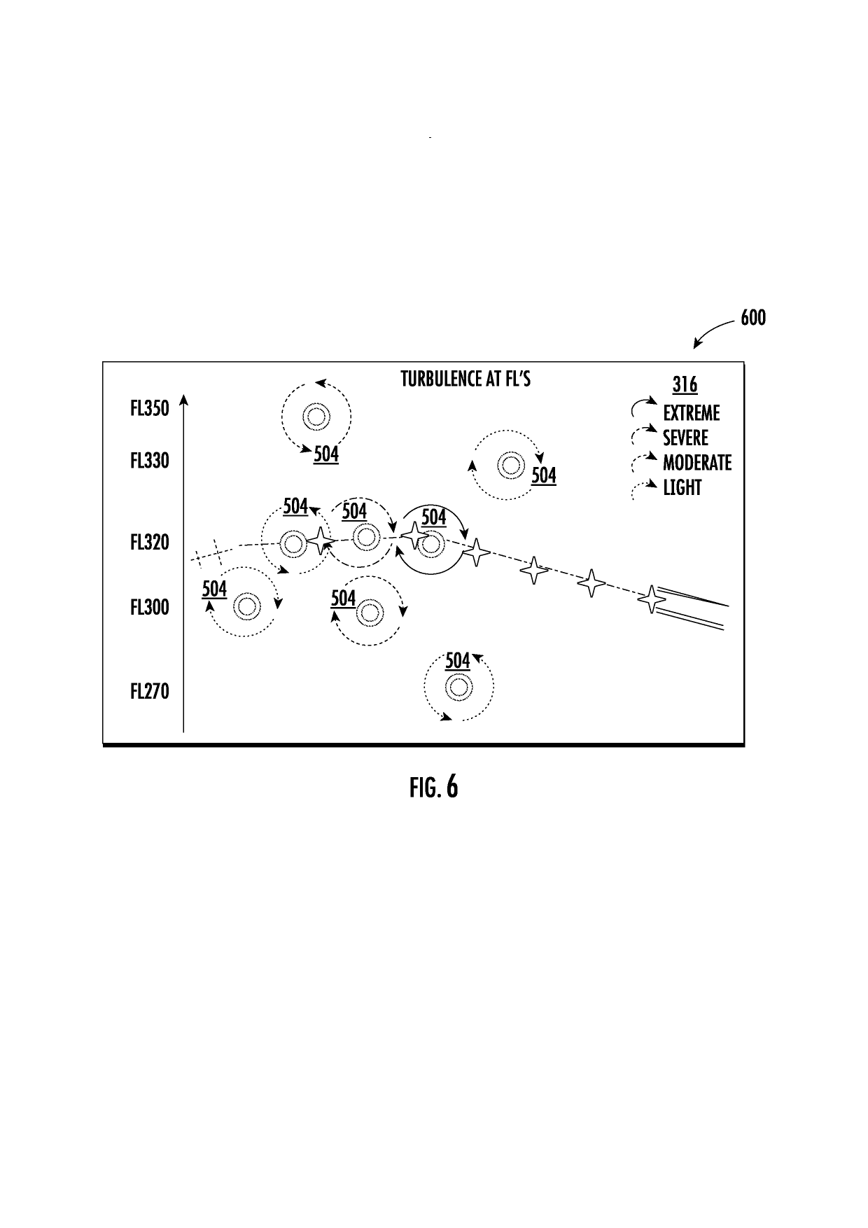

FIG. 6 illustrates an interface 600 showing a visualization of turbulence intensity classification in accordance with at least one example embodiment of the present disclosure. In some embodiments, the interface 600 comprises a navigation display configured to present clear air turbulence predictions along the flight path. The interface 600 may include a graphical representation of the flight path overlaid with turbulence intensity indicators corresponding to one or more locations within the spatial region. In some embodiments, the turbulence intensity indicators are color-coded to visually distinguish between different turbulence intensity classifications, such as null, light, light-to-moderate, moderate, moderate-to-severe, severe, severe-to-extreme, or extreme. For example, regions associated with light turbulence may be rendered in a first color (e.g., green or yellow), regions associated with moderate turbulence may be rendered in a second color (e.g., orange), and regions associated with severe or extreme turbulence may be rendered in a third color (e.g., red). In some embodiments, the interface 600 includes turbulence intensity indicators at multiple flight levels, enabling pilots to identify smoother air at higher or lower altitudes relative to the current aircraft flight level. The interface 600 may further include graphical elements representing the current aircraft position, planned waypoints, and route segments along the flight path. In some embodiments, the interface 600 includes one or more alert elements configured to display notifications or recommendations based on the predicted turbulence dataset, such as a "seat belt on" indicator for light or moderate turbulence conditions, or recommendations for flight level changes or lateral route deviations for severe or extreme turbulence conditions. The interface 600 may be rendered on a display component of a client computing device 102, such as an electronic flight bag, a multi-function control and display unit (MCDU), a primary flight display, or other suitable display device accessible to the pilot or flight crew. In some embodiments, the interface 600 comprises a Clear Air Turbulence Situational Display that presents turbulence predictions along the flight plan, thereby facilitating flight planning improvements with respect to weather awareness and avoidance. The interface 600 may include interactive elements that allow the user (e.g., pilot) to select alternative flight levels or lateral deviations and view corresponding turbulence predictions for the selected alternatives, enabling informed decision-making regarding flight path modifications that may result in more optimal fuel burn and reduced carbon dioxide emissions.

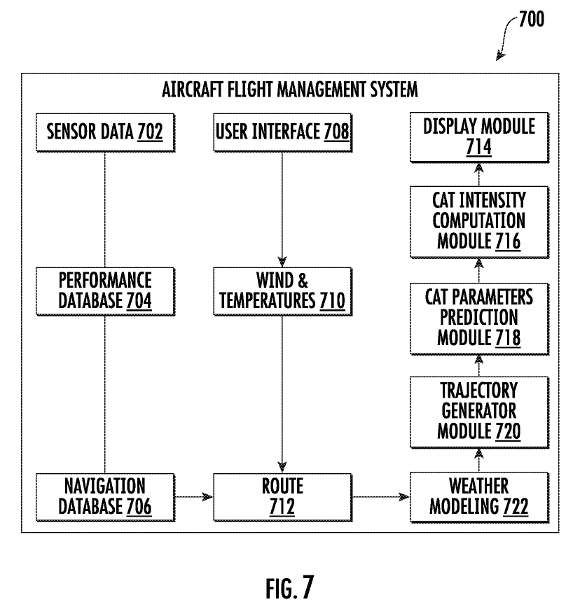

FIG. 7 illustrates an operational example of a flight management system 700 in which example embodiments of the present disclosure may operate. In some embodiments, the flight management system 700 comprises an onboard flight management system installed within an aircraft. In some embodiments, the flight management system 700 comprises a connected flight management system (cFMS) configured to exchange data with external computing devices, client computing devices (such as electronic flight bags), and/or cloud-based systems via secure connections in real time.

In some embodiments, the flight management system 700 includes one or more components including a weather modeling module 722, a trajectory generator module 720, a CAT parameters prediction module 718, a CAT intensity computation module 716, a display module 714, a user interface 708, a navigation database 706, and/or a performance database 704. One or more components of the flight management system may correspond to one or more components of the predictive computing device 106. For example, in some embodiments, flight management system 700 includes the predictive computing device 106 or one or more components thereof, such as the weather modeling module (corresponding to weather modeling module 722), the trajectory generator module (corresponding to the trajectory generator module 720), the CAT parameters prediction module (corresponding to the CAT parameters prediction module 718), the CAT intensity computation module (corresponding to the CAT intensity computation module 716) and/or the display module (corresponding to the display module 714). In some embodiments, the flight management system 700 includes a mission manager partition configured to perform clear air turbulence prediction operations while leveraging the trajectory computation capabilities and performance expertise of the flight management system 700.

The flight management system may receive and/or store sensor data 702 and weather data 710 (e.g., wind and temperature data) that support and/or facilitate one or more functionalities of the flight management system 700. In some embodiments, the flight management system 700 is configured to receive input data from multiple sources including onboard sensors that measure current atmospheric conditions at the aircraft location, pilot-entered weather data input via a flight management system interface (such as a multi-function control and display unit), uplinked weather data received from ground-based systems or air traffic control, and network weather data obtained from connected aircraft systems or cloud-based weather services. The flight management system 700 may be configured to provide trajectory data, aircraft position data, altitude data, and timing information to the predictive computing device 106 or components thereof for use in generating clear air turbulence predictions along the flight path.

In some embodiments, the trajectory generator module 720 is configured to generate trajectory data at various flight levels along and around the planned route 712. The trajectory generator module 720 may leverage flight optimization trajectory computation capabilities to determine aircraft position, altitude, and timing information along the flight path. In some embodiments, the flight management system 700 is configured to compute trajectory data for multiple flight levels, including the current aircraft flight level and alternative flight levels above and below the current flight level, as described herein.

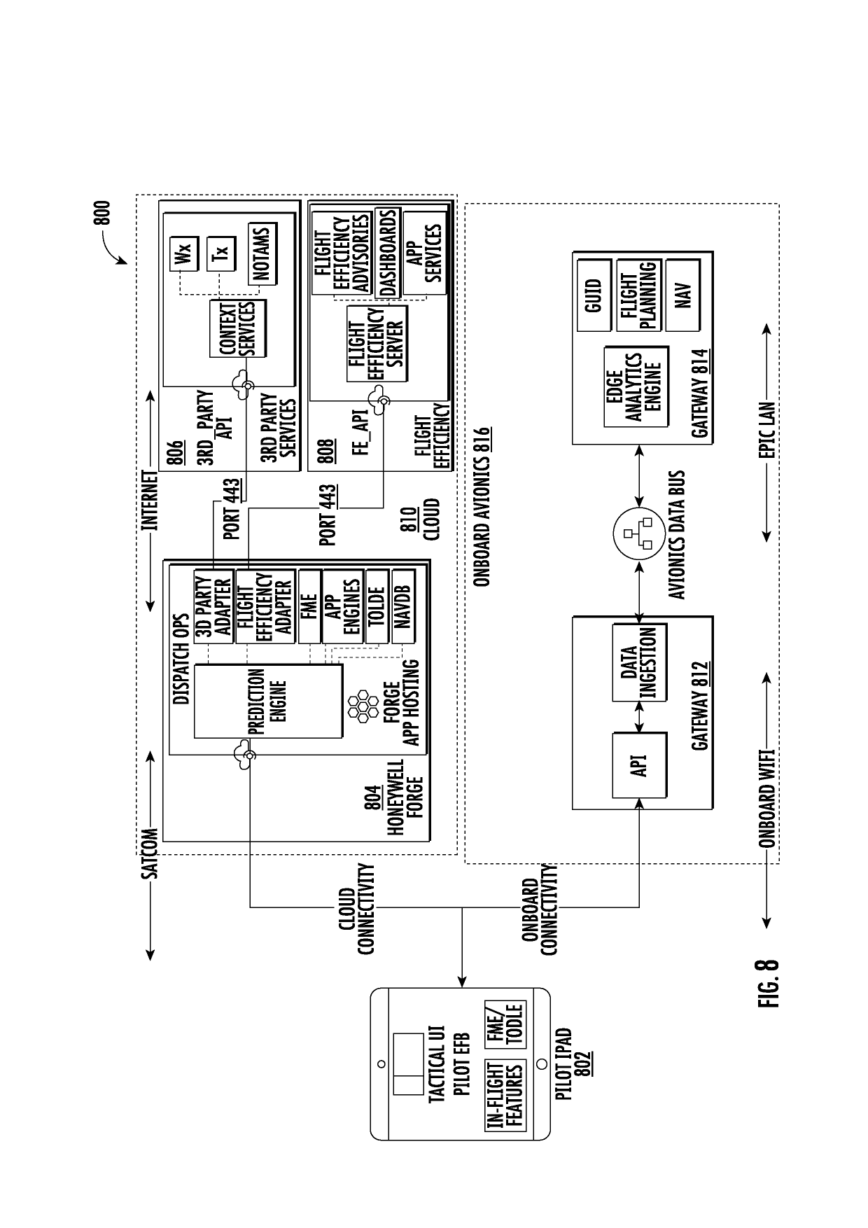

FIG. 8 illustrates an example of a connected aircraft system architecture 800 in which example embodiments of the present disclosure may operate. In some embodiments, the connected aircraft system architecture 800 comprises a plurality of interconnected components configured to facilitate clear air turbulence prediction operations in a connected aircraft environment. The connected aircraft system architecture 800 may include a user device 802, a cloud-based computing platform 810, an avionics platform 816, and/or one or more communication links/interfaces configured to enable real-time data exchange between the various components. The user device 802 may comprise a client computing device such as client computing device 102. By way of example, the user device 802 may comprise a pilot pad, an electronic flight bag (EFB), a tablet computer, or other portable computing device configured to interface with the connected aircraft system architecture 800. In some embodiments, the user device 802 is configured to display clear air turbulence predictions, receive pilot input for weather data entry, and facilitate interaction with the clear air turbulence prediction system.

In some embodiments, the cloud-based computing platform 810 comprises one or more cloud-based services and components configured to support clear air turbulence prediction operations. The cloud-based computing platform 810 may include an IoT (Internet of Things) platform 804 configured to facilitate connectivity and data exchange between aircraft systems and cloud-based services. The cloud-based computing platform 810 may further include a third-party services component 806 configured to provide access to external weather data sources, atmospheric models, or other data services that may be leveraged for clear air turbulence prediction. In some embodiments, the cloud-based computing platform 810 includes a flight efficiency component 808 configured to perform flight optimization computations, including clear air turbulence prediction operations that leverage the computing resources and data aggregation capabilities of the cloud-based environment. The flight efficiency component 808 may be configured to receive input data from multiple aircraft, aggregate atmospheric data across a broader geographic region, and generate clear air turbulence predictions that may be distributed to connected aircraft operating within the relevant airspace.

In some embodiments, the avionics platform 816 comprises one or more avionics components installed within the aircraft, including one or more avionics data buses communicatively coupled to one or more gateways (e.g., gateway 812, gateway 814). The gateways 812, 814 may be configured to facilitate secure data exchange between the avionics platform 816 and external systems, including the cloud-based computing platform 810 and the user device 802. In some embodiments, the avionics platform 816 includes a flight management system (FMS) configured to provide trajectory data, aircraft position data, altitude data, and timing information to support clear air turbulence prediction operations. The avionics platform 816 may further include onboard sensors configured to measure current atmospheric conditions at the aircraft location, including wind data and temperature data that may be leveraged by the one or more prediction models to generate clear air turbulence predictions. In some embodiments, the connected aircraft system architecture 800 enables the computing system 101 or predictive computing device 106 to be implemented in a distributed manner, wherein certain clear air turbulence prediction operations may be performed onboard the aircraft (e.g., by the avionics platform 816 or user device 802) while other operations may be performed by the cloud-based computing platform 810, thereby leveraging the computational resources and data aggregation capabilities of the connected aircraft environment.

### EXAMPLE COMPUTER-IMPLEMENTED PROCESSES OF THE DISCLOSURE

Having described example systems, apparatuses, and data architectures in accordance with the present disclosure, example processes for generating optimal conceptual design and example processes for optimal site selection will now be discussed. In particular, example processes for predicting clear air turbulence will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

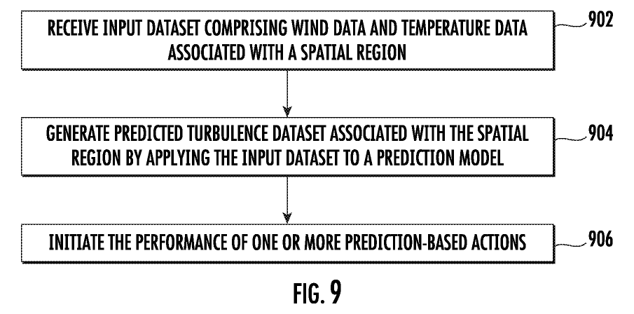

FIG. 9 illustrates a flowchart including example operations of an example process for generating clear air turbulence predictions in accordance with at least one example embodiment of the present disclosure. Specifically, FIG. 9 illustrates an example computer-implemented process 900 (computer-implemented method) for predicting clear air turbulence for an aircraft. The process 900 may be performed by the computing system 101 (or one or more components thereof), or apparatus 200. In some embodiments, the process 900 is embodied by computer program code stored on a non-transitory computer-readable storage medium of a computer program product configured for execution to perform the process as depicted and described. Alternatively, or additionally, in some embodiments, the process 900 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. For purposes of simplifying the description, the process 900 is described as performed by and from the perspective of the apparatus 200.

In some embodiments, the process 900 comprises at operation 902, receiving an input dataset. For example, the apparatus 200 may include one or more circuitries (e.g., one or more of circuitries 202-210) that receives an input dataset. In some embodiments, the input dataset may be received from one or more external computing devices. In some embodiments, the input dataset comprises wind data and temperature data for a spatial region associated with a flight path for an aircraft. In some embodiments, the wind data comprises measured wind metric for one or more locations within the spatial region. In some embodiments, the temperature data comprises measured temperature for the one or more locations within the spatial region. Each location may be defined by and/or correspond to a flight level (e.g., altitude) and lateral distance from a reference location (e.g., waypoint) along a flight path. In some embodiments, the input dataset may be received from multiple sources including onboard sensors that measure current atmospheric conditions at the aircraft location, pilot-entered data input via a flight management system interface, uplinked data received from ground-based systems or air traffic control, and network weather data obtained from connected aircraft systems or cloud-based weather services.

For example, the spatial region may correspond to or be associated with a weather model that defines a plurality of locations including a reference location (e.g., waypoint) along a flight path of the aircraft and a plurality of locations proximate to (or otherwise around) the reference location in a longitudinal direction and lateral direction. For example, the wind data may comprise measured wind metric along a flight path for an aircraft at one or more flight levels (e.g., altitudes). Alternatively, or additionally, the wind data may comprise measured wind data at a lateral distance (e.g., left and/or right) along the flight path and at one or more flight levels. In some embodiments, the spatial region extends laterally from the flight path up to a predetermined distance, such as approximately 25 nautical miles on either side of the route, which represents an operationally safe deviation distance from the route. In some embodiments, the spatial region further extends vertically across multiple flight levels, including at the aircraft flight level and at flight levels above and below the aircraft flight level (e.g., at approximately 50 feet below and approximately 50 feet above the aircraft flight level), thereby enabling the apparatus 200 to evaluate atmospheric conditions across both a lateral and vertical range of the spatial region.

In some embodiments, the process 900 comprises at operation 904 generating predicted turbulence dataset associated with a spatial region associated with a flight path for an aircraft. For example, the apparatus 200 may include one or more circuitries (e.g., one or more of circuitries 202-210) that generates predicted turbulence dataset associated with the spatial region. In some embodiments, the apparatus 200 generates the predicted turbulence dataset by applying the input dataset to one or more prediction models configured to generate turbulence intensity data for the spatial region. In some embodiments the turbulence intensity data comprises calculated turbulence intensity for each of the one or more locations (computation points) within the spatial region.

By way of example, for a given aircraft type, turbulence intensity (e.g., turbulence intensity data) may be calculated using one or more algorithms. In some embodiments, the apparatus 200 (e.g., using the one or more prediction models) may generate atmospheric variation dataset based on the wind data and temperature data; generate predicted airflow direction data based on the atmospheric variation data; and generate the turbulence intensity data based on atmospheric variation dataset or the predicted airflow direction data. For example, the one or more prediction models may be configured to calculate one or more atmospheric metrics along and around the aircraft flight path. In some embodiments, the one or more prediction models may be configured to calculate the one or more atmospheric metrics within a predetermined distance in a lateral direction relative to the aircraft flight path. In one example the predetermined distance is about 25nm left of a reference point (e.g., waypoint) along the flight path and about 25nm right of the reference point along. In some embodiments, the one or more prediction models compute atmospheric parameters at multiple flight levels, including at the aircraft flight level and at flight levels above and below the aircraft flight level (e.g., at approximately 50 feet below and approximately 50 feet above the aircraft flight level), to identify atmospheric conditions across a vertical range of the spatial region. In some embodiments, the one or more prediction models estimates air stream directions through pressure and temperature variations over the computation region, wherein pressure variations at a point of interest help in determining the direction of air flow based on the principle that air flows from high pressure to low pressure areas.

In some embodiments, the atmospheric variation dataset comprises one or more of pressure variation data or temperature variation data. For example, the computing system 101 (e.g., using the one or more prediction models) may be configured to calculate pressure variation and/or temperature variation within the spatial region, and to predict air flow direction(s) based on the calculated pressure variation and/or temperature variation. In some embodiments, the one or more prediction models identifies potential vortices or air pockets based on directional differences in pressure variations at computation points within the spatial region. For example, where pressure variations indicate air flowing from high pressure to low pressure in different directions at a computation point, the directional difference in pressure variations may lead to potential vortices or air pockets at that computation point, which may be indicative of clear air turbulence. In some embodiments, the predicted turbulence dataset comprises a turbulence intensity classification corresponding to one or more locations within the spatial region based on the turbulence intensity data. In some embodiments, the intensity classification comprises extreme, severe, moderate, or light. In some embodiments, the turbulence intensity classification may include additional granularity, such as null, light, light-to-moderate, moderate, moderate-to-severe, severe, severe-to-extreme, or extreme classifications. In some embodiments, the one or more prediction model leverages EDR values to classify turbulence intensity,

For example, a location within the spatial region associated with clear air turbulence may be classified as one of extreme, severe, moderate, or light. In some examples, the turbulence intensity classification may be leveraged by an operator (e.g., a pilot or the like) or the system in making decisions. For example, where the turbulence intensity classification is light or moderate, the operator or the system may alert proactively to passengers (e.g., "seat belt on"). As another example, where the turbulence intensity classification is severe or extreme, the operator or the system may plan a deviation (e.g., flight level change or lateral route) proactively.

In some embodiments, the process 900 comprises at operation 906 initiating the performance of one or more prediction-based actions. For example, the apparatus 200 may be configured to initiate performance of one or more prediction-based actions based at least in part on the predicted turbulence dataset. In some embodiments, initiating the performance of the one or more prediction-based actions comprises generating and transmitting an alert to one or more client computing devices. In some embodiments, initiating the performance of the one or more prediction-based actions comprises generating a representation of the predicted turbulence dataset and causing display of the representation of the predicted turbulence dataset on a display of a client computing device 102. In some embodiments, the representation of the predicted turbulence dataset comprises a Clear Air Turbulence Situational Display that presents turbulence predictions along the flight plan, thereby facilitating flight planning improvements with respect to weather awareness and avoidance. In some embodiments, the representation includes color-coded regions, icons, or other graphical indicators overlaid on a navigation display, wherein each graphical indicator corresponds to a location within the spatial region and visually distinguishes between turbulence intensity levels. In some embodiments, initiating the performance of the one or more prediction-based actions comprises controlling one or more physical components of the aircraft based on the predicted turbulence dataset. In some embodiments, initiating the performance of the one or more prediction-based actions comprises transmitting the predicted turbulence dataset or a portion thereof to one or more external computing devices 108, such as air traffic control systems, ground-based flight operations centers, or connected aircraft systems associated with other aircraft operating in the same airspace. In some embodiments, initiating the performance of the one or more prediction-based actions comprises automatically adjusting a flight plan based on the predicted turbulence dataset, wherein the apparatus 200 may compute alternative flight paths or altitude profiles that avoid or minimize exposure to predicted clear air turbulence regions within the spatial region.

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method comprising:
receiving , by one or more processors, an input dataset comprising wind data and temperature data for a spatial region associated with a flight path for an aircraft;
generating, by the one or more processors, predicted turbulence dataset associated with the spatial region by applying the input dataset to a prediction model configured to generate turbulence intensity data for the spatial region, wherein the predicted turbulence dataset comprises a turbulence intensity classification corresponding to one or more locations within the spatial region based on the turbulence intensity data; and
initiating, using the one or more processors, performance of one or more prediction-based actions based at least in part on the predicted turbulence dataset.

2. The computer-implemented method of claim 1, wherein the wind data comprises measured wind metric for one or more locations within the spatial region.

3. The computer-implemented method of claim 1, wherein the temperature data comprises measured temperature for the one or more locations within the spatial region, wherein each location is defined by a flight level and lateral distance from a reference location.

4. The computer-implemented method of claim 1, wherein generating the predicted turbulence dataset comprises:
generating atmospheric variation dataset based on the wind data and temperature data;
generating predicted airflow direction data based on the atmospheric variation dataset; and
generating the turbulence intensity data based on the atmospheric variation dataset or predicted airflow direction data.

5. The computer-implemented method of claim 1, wherein initiating the performance of the one or more prediction-based actions comprises:
generating a representation of the predicted turbulence dataset; and
causing display of the representation of the predicted turbulence dataset on a display of a client computing device.

6. The computer-implemented method of claim 1, wherein the turbulence intensity data comprises calculated turbulence intensity for each of the one or more locations within the spatial region.

7. The computer-implemented method of claim 4, wherein the atmospheric variation dataset comprises one or more of pressure variation data or temperature variation data.

8. An apparatus comprising at least one processor and at least one memory storing instructions that, when executed by the at least one processor, cause the apparatus to:
receive an input dataset comprising wind data and temperature data for a spatial region associated with a flight path for an aircraft;
generate predicted turbulence dataset associated with the spatial region by applying the input dataset to a prediction model configured to generate turbulence intensity data for the spatial region, wherein the predicted turbulence dataset comprises a turbulence intensity classification corresponding to one or more locations within the spatial region based on the turbulence intensity data; and
initiate performance of one or more prediction-based actions based at least in part on the predicted turbulence dataset.

9. The apparatus of claim 8, wherein the wind data comprises measured wind metric for one or more locations within the spatial region.

10. The apparatus of claim 8, wherein the temperature data comprises measured temperature for the one or more locations within the spatial region, wherein each location is defined by a flight level and lateral distance from a reference location.

11. The apparatus of claim 8, wherein generating the predicted turbulence dataset comprises:
generating atmospheric variation dataset based on the wind data and temperature data;
generating predicted airflow direction data based on the atmospheric variation dataset; and
generating the turbulence intensity data based on the atmospheric variation dataset or the predicted airflow direction data.

12. The apparatus of claim 8, wherein initiating the performance of the one or more prediction-based actions comprises:
generating a representation of the predicted turbulence dataset; and
causing display of the representation of the predicted turbulence dataset on a display of a client computing device.

13. The apparatus of claim 8, wherein the turbulence intensity data comprises calculated turbulence intensity for each of the one or more locations within the spatial region.

14. The apparatus of claim 11, wherein the atmospheric variation dataset comprises one or more of pressure variation data or temperature variation data.

15. At least one non-transitory computer-readable storage medium, the at least one non-transitory computer-readable storage medium having computer coded instructions configured to, when executed by at least one processor:
receive an input dataset comprising wind data and temperature data for a spatial region associated with a flight path for an aircraft;
generate predicted turbulence dataset associated with the spatial region by applying the input dataset to a prediction model configured to generate turbulence intensity data for the spatial region, wherein the predicted turbulence dataset comprises a turbulence intensity classification corresponding to one or more locations within the spatial region based on the turbulence intensity data; and
initiate performance of one or more prediction-based actions based at least in part on the predicted turbulence dataset.

16. The at least one non-transitory computer-readable storage medium of claim 15, wherein the wind data comprises measured wind metric for one or more locations within the spatial region.

17. The at least one non-transitory computer-readable storage medium of claim 15, wherein the temperature data comprises measured temperature for the one or more locations within the spatial region, wherein each location is defined by a flight level and lateral distance from a reference location.

18. The at least one non-transitory computer-readable storage medium of claim 15, wherein generating the predicted turbulence dataset comprises:
generating atmospheric variation dataset based on the wind data and temperature data;
generating predicted airflow direction data based on the atmospheric variation dataset; and
generating the turbulence intensity data based on the atmospheric variation dataset or the predicted airflow direction data.

19. The at least one non-transitory computer-readable storage medium of claim 15, wherein initiating the performance of the one or more prediction-based actions comprises:
generating a representation of the predicted turbulence dataset; and
causing display of the representation of the predicted turbulence dataset on a display of a client computing device.

20. The at least one non-transitory computer-readable storage medium of claim 15, wherein the turbulence intensity data comprises calculated turbulence intensity for each of the one or more locations within the spatial region.
